(19) United States
(12) Patent Application Publication
(10) Pub. No.: US 2019/0246165 A1
(43) Pub. Date: Aug. 8, 2019

(54) Messaging and commenting for videos

(71) Applicants: Robert Brouwer, Kusnacht (CH); Ahmed Abdulwahab, Berlin (DE)

(72) Inventors: Robert Brouwer, Kusnacht (CH); Ahmed Abdulwahab, Berlin (DE)

(21) Appl. No.: 16/341,895

(22) PCT Filed: Oct. 18, 2017
(86) PCT No.: PCT/IB2017/056479

§ 371 Date: Apr. 13, 2019

Related U.S. Application Data
(63) Continuation-in-part of application No. PCT/IB2017/053039, filed on May 23, 2017.
(60) Provisional application No. 62/409,473, filed on Oct. 18, 2016.

(51) Int. Cl. H04N 21/435; H04N 21/845; H04N 21/44; H04N 21/84

(52) U.S. Cl. CPC H04N 21/435; H04N 21/84; H04N 21/44; H04N 21/845

(57) ABSTRACT

Methods, processes and systems for contextually augmenting and annotating moving pictures or images with tags using region tracking on computing devices with screen displays, including mobile devices and virtual reality headsets. The present invention enables both content authors and viewers to directly tag and link supplementary content, such as text and video messages, to locations representative of objects in a moving picture or image and share these tags with other authorized users, thereby facilitating messaging.

### CROSS REFERENCE TO RELATED APPLICATIONS

The present application is a continuation-in-part of PCT application no. PCT/IB2017/053039, filed on May 23, 2017, and claims the benefit of co-pending U.S. provisional application No. 62/409,473, filed on Oct. 18, 2016, the entire disclosure of each of which is incorporated by reference as if set forth in its entirety herein.

### TECHNICAL FIELD

This disclosure relates to systems and methods for annotating video, and in particular to systems and methods for facilitating commenting and messaging associated with particular portions of a video that may reflect the presence of an object in various frames of the video.

### BACKGROUND

In existing chat or messaging solutions, a user generally selects another user for communications, types a message, and then initiates the communication by sending the message. In case of a text messaging system, the user enters or selects the name of the recipient or recipients and then types a message in a designated message field. When the user presses return on the keyboard or send, post, or a similar button the message is then send. The recipient or recipients then receive the message and can reply to that message in a similar way, not necessarily requiring identifying the sender who wrote the message. In case of audio or video communications, a user selects the person with whom to speak and then clicks the call button to establish communications with that person.

Existing video hosting and video streaming platforms, such as YouTube, Vimeo and other platforms are designed to deliver video content. Their commenting functionality is separate, so that users can post mostly comments below the video available to all viewers of that content. These comments are only associated with the video at top level. When a user selects a different video, the corresponding comments are then all displayed. As far as point to point messages are concerned, these platforms generally do not have this type of communication integrated.

Communication platforms, such as WhatsApp, Skype and other known communication applications, are designed for general communications and are generally independent of any other application such as, word processing and photo editing applications, video player, websites and the respective content.

When it comes to communicating effectively within visual content, such as images or videos, existing communication applications, as mentioned above, have limitations. This is the case, when for example two users want to discuss specific details in a video scene. Both users would need to view the video, probably independently, unless they were both sitting together watching the same video. During viewing, each user may at any point in time have a question, a comment or a remark about any object or scenario or scene. Screen-sharing could be a helpful tool in this discussion, because users can share their point of view in the content with the other person. This is not always an option, especially when both users are unavailable at the same time. Therefore, it can be difficult to work asynchronously with video content and images and screen-sharing is not a perfect solution.

When a user has questions or comments about a particular scene in a video or image, he can, for example, communicate with other users by leaving a comment or sending a message using an independent chat application as mentioned above. In both cases the users must refer to the title of the video and also provide more information and details, such as, author and publishing date. Moreover, a user must also transmit the time of the particular scene so that the recipient understands where his questions relate to. Without this information such communication will not be effective. The recipient then needs to look and maybe search for the video, unless the other user pasted the URL of the video in the message, or he submitted the URL containing the section information, which is an additional feature on video hosting platforms such as YouTube. Otherwise the recipient may need to manually skip to the time in the video to understand what the question is about. This is obviously a very time-consuming and inefficient process.

In addition, the problem is that the more comments have been sent for a movie, the higher the chances are that comments are overlooked or remain unanswered. Especially when a large number of comments are being received, older comments are generally moved to the bottom of the stack, disappearing from view and getting potentially unnoticed.

Accordingly, there is a need for systems and methods to overcome these disadvantages.

### SUMMARY

Embodiments of the present invention provide methods and processes for users to communicate or chat with other users on video hosting or streaming platforms, including websites with videos or images, by means of audio, video or text messaging or other forms of communication services or methods. Embodiments of the invention enable users to directly communicate with other users, whereby any of the communication methods are either associated with, or linked to, either at least one video frame of a video, or an image, or they are associated with, or linked to, at least one object, identified by a user in a video or an image.

In embodiments of the present invention, the general form of communications between at least two users is similar. The communication originates either in a video frame of a video or an image, whereby the communication is physically associated or linked to either a particular frame of a video or an image, or to an identified object in a particular video frame of a video or an image.

Embodiments of the present invention combine a messaging or communication service with either the video frame or an object in a video frame, thus enabling comments, messages and other forms of communications to be associated with either a frame of a video, or an image, or with an object, that the user or other users identified in the video or image. This invention allows users to view messages that relate to messages or comments of either particular video frames or images, or to identified objects in videos or images, making it far easier to comprehend scenarios, scenes and objects in videos or images.

Embodiments of the present invention are particularly useful when videos and images are predominantly used, such as in online education, customer service, arts and design, fashion, marketing and other areas. Any application that uses visuals and requires several groups to communicate may benefit from this invention. Embodiments of the present invention make it possible for users to ask, for example, specific questions about an object, a scene or any other item or items that appear at a particular point in time in a video or an image. For example, a user can ask what color a particular cube has, when various cubes are displayed at the same time a video. Or for example, a building interior, which shows various colors and materials used, and users may have questions about the color or materials used. With the present invention it is possible to place tags on specific elements of an interior shown in a video. Each tag may contain a comment or message about the color or material used so that users can interact with that tag to read the comment or answer a particular question in the video.

Yet another example is for fashion presentations. When fashion models present the latest collection, it is possible that users ask, for example, questions about any of the clothes or accessories being worn. With embodiments of the present invention, users, including the author or publishers of the video, can respond to these messages or comments in the video. Users can send messages or comment in tags, which are associated with a frame or an identified object (pixel region), to ask about details such as fabric types, materials, sizes, colors available and other information such as where to purchase the items and other users can comment and send messages from within the video. Users can at any time access the tags and collect the information that was added. Because Tags are associated with a frame or an object, messages can be shared and read and the relevant tag will always point to the source in the video content offering a fast and efficient feedback mechanism.

In one aspect, embodiments of the invention relate to a method to facilitate communications. The method includes receiving a selection of a location in a starting video frame from a user; identifying a first group of pixels in proximity to the selected location; determining whether the first group of pixels can be tracked through subsequent video frames for a predetermined period of time; permitting the user to attach a tag to the selected location if the first group of pixels can be tracked for the predetermined period of time; and enabling the user to associate a message with the tag.

In one embodiment, the method further includes playing the video while displaying the tag attached to the first group of pixels beginning at the starting video frame and finishing after the predetermined period of time.

In one embodiment, the tag is displayed to a first user and is not displayed to a second user.

In one embodiment, the predetermined period of time is approximately four seconds.

In one embodiment, the method further includes enabling a second user to associate a second message with the message already associated with the tag.

In one embodiment, the method further includes displaying the associated message upon interaction with the displayed tag.

In one embodiment, the method further includes disabling the display of the tag during subsequent plays of the video.

In one embodiment, the attached tag is stored in a transparent overlay separate from the video.

In one embodiment, information concerning the attached tag is stored in a database.

In one embodiment, the method further includes selecting a second, larger, group of pixels in proximity to the selected location when the first group of pixels cannot be tracked for the predetermined period of time. In one embodiment, the method further includes determining whether the second group of pixels can be tracked through subsequent video frames for a predetermined period of time. In one embodiment, the predetermined period of time is four seconds.

In another aspect, embodiments of the present invention relate to a system for to facilitate communications. The system includes a source of video content; a database of tags, each tag being associated with an element in a video content for a predetermined period of time; and a database of messages, each message being associated with a tag.

In one embodiment, the system further includes a player to display video content from the source of video content and at least one tag from the database of tags in proximity to the element in the video with which it is associated.

In one embodiment, the player displays the at least one tag in a transparent layer overlaid on the displayed video content.

In one embodiment, the system further includes an editor to receive a selection of a location in a video content from a user.

In one embodiment, the system further includes a pixel tracker to track a collection of pixels near the selected location through subsequent frames of the video content.

In one embodiment, the pixel tracker checks the presence of the pixel collection in a plurality of keyframes.

In one embodiment, the system further includes an object tracker to track an object near the selected location through subsequent frames of the video content.

In one embodiment, the object tracker tracks the object through the next four seconds of video content.

### BRIEF DESCRIPTION OF THE DRAWINGS

Exemplary embodiments of the present disclosure will be understood from the following detailed description when read with the accompanying Figures. In the drawings, like reference numerals refer to like parts throughout the various views of the non-limiting and non-exhaustive embodiments of the present invention, and wherein:

FIG. 1 shows one embodiment of a server platform providing video annotations in accord with the present invention;

FIG. 2 shows a mobile computing device playing a streamed video;

FIGS. 3-18c show an example of a user annotating a video and interacting with an annotated video in accord with the present invention;

FIG. 19 presents a method of displaying a video and the associated tags;

FIG. 20 illustrates how the system operates when it cannot successfully track a region of pixels representative of an object for a predetermined time;

FIG. 21 identifies the steps in the pixel region tracking process;

FIG. 22 shows one exemplary application of the pixel region tracking process;

FIG. 23 is a flowchart describing the attachment of a tag to a specific position in a video;

FIG. 24 presents the method for a user interacting with a tagged video;

FIG. 25 presents an example of a contextual dynamic content layer;

FIG. 26 illustrates various embodiments of contextual dynamic content layering;

FIG. 27 depicts a video player showing a video frame with tagged objects;

FIG. 28 presents various examples of exemplary tag markers;

FIG. 29 shows the expansion of comments associated with a tag marker associated with an object;

FIG. 30 shows the expansion of comments associated with a tag marker associated with another object;

FIG. 31 shows the use of general tags and object tags in a video frame;

FIG. 32 shows one embodiment of a system for offering video commenting and messaging;

FIG. 33 shows a video as a series of video frames;

FIG. 34 shows the persistence of messages associated with an object across multiple video frames;

FIG. 35 shows a plurality of messages associated with a plurality of tag markers;

FIG. 36 depicts one example of a message or comment container;

FIG. 37 depicts another example of a message or comment container;

FIG. 38 presents a flowchart of a workflow for viewing and replying to a message or a comment;

FIG. 39 presents a flowchart of a workflow for creating a new message or comment tag in a video;

FIG. 40 shows one example of a message viewer in accord with the present invention; and

FIG. 41 depicts the message viewer of FIG. 40.

### DETAILED DESCRIPTION

Embodiments of the present invention provide a method and process for users to communicate or chat with other users on video hosting or streaming platforms, including websites with videos or images, by using audio, video or text messaging or other forms of communication services. Embodiments of this invention enable users to directly communicate with other users, whereby the communication is associated with a video frame of a video or an image, or is associated with an object that has been identified by a user in a video or an image.

The anchor for communications in this invention is an object that a user identifies in a video frame or image, or a video frame itself, to which a Message or Communication Tag is associated or linked. The linking is not a physical connection.

This is different from general communication platforms existing today, which provide for messaging independent of any content linkage. These existing communication platforms are primarily designed to facilitate communications between users. A user typically selects or enters the name of a person to send a message to, or a group of persons to communicate with. After entering the text, in a message field, for example, a user sends the message to the other user or users.

In embodiments of the present invention there are, besides the actual message and users, also the associated content, which is the anchor for communications, whereby the anchor or link between the message and the content is by means of a tag. The message or comments, or other form of communications such as audio or video chat communications are associated with either a video frame or with an identified object in a video or an image in a video frame.

### Object Tracking and Tagging

By way of background, embodiments of the present invention allow contextually augmenting and annotating moving pictures or images with tags using pixel region tracking on computing devices with screen displays, including mobile devices and virtual reality headsets. Embodiments of the present invention enable both content authors and viewers to directly tag and link supplementary content to a region corresponding to an object in a moving picture or an image and share these tags with other users. In some embodiments this supplementary content includes messages or comments.

The present invention relates to a platform which allows users to annotate a moving picture or image. Users can tag any region they identify in the video. Region tracking is used to detect and track the region that the user decided to annotate or tag for a predetermined time. Users can add content such as videos, comments, messages and other embedded content and or information to these tags. As a result, the platform offers a superior level of interaction and a more immersive consumption experience than traditional videos without this form of annotations.

For this reason, one of ordinary skill should understand any and all references to “objects” and “object tracking” herein (both by themselves and as part of phrases such as “object tracking analysis,” etc.) to be interchangeable with specific references to one or more of “pixels,” “regions,” “pixel regions,” “pixel tracking,” “pixel region tracking,” “tracking,” “region tracking,” and the other techniques both discussed herein as well as those known to one of ordinary skill.

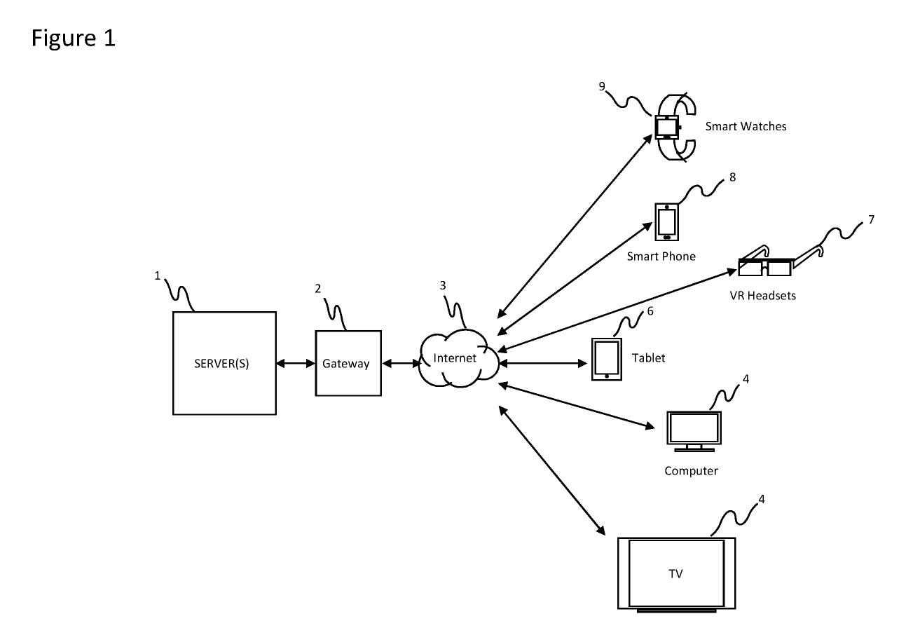

FIG. 1 shows an example of a server platform that can be used to offer one embodiment of the present invention. The platform includes at least one software client, which can also be an app, web app, website, plug-in, etc., (or any code that establishes direct communications with the services running on at least a server) running on a computing device, connected to a screen display or VR Headset (5,6,7,8,9). The software client may or may not be a dedicated client. The computing device, whether fixed or mobile, communicates over a standard network connection (3) using standard connection methods to a gateway (2) with at least one server (1) on the backend as shown in FIG. 1. The system may exist in distributed forms, or in a cloud environment, and/ or as a standalone version or versions. In one embodiment, certain components such as user tracking, business intelligence, object tracking, or the supplementary or primary content may reside on a separate server or servers at a different location or different locations.

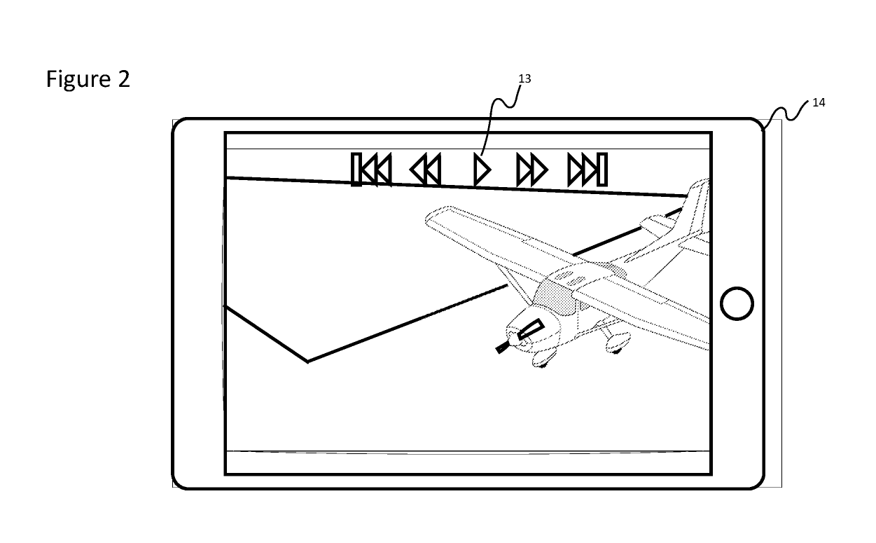

Video content can be played back and/or created using software on a computing device. In this example, FIG. 2 shows a mobile computing device (14) playing a video that is streamed from a server (1) to the device. The computing device (14) features standard controls known to video streaming applications (13). In one embodiment, there may be different clients or software applications with different types of controls with different functions that can be activated for specific users or user groups. In another embodiment, existing movie controls utilized by the playback software are used and additional controls and/or functions can be made available. In this embodiment relevant data traffic associated with the tags, supplementary content and communications, is directed to the server (1) while the primary content, or other services may reside on a separate or existing server infrastructure.

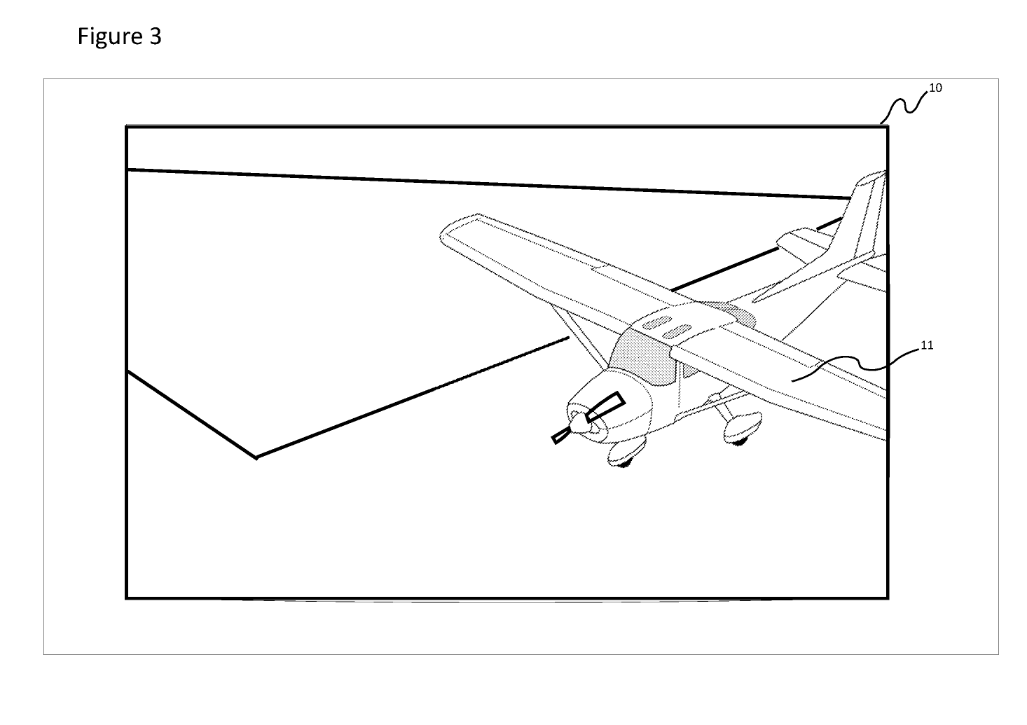

FIGS. 3 to 18c depict one example of what a user experiences when creating and interacting with annotations or tags in one embodiment of the present invention. In overview, identified regions are marked with dots and associated tags are placed on the bottom of the screen. In another embodiment, identified regions are directly marked with icons using the same region identification method described.

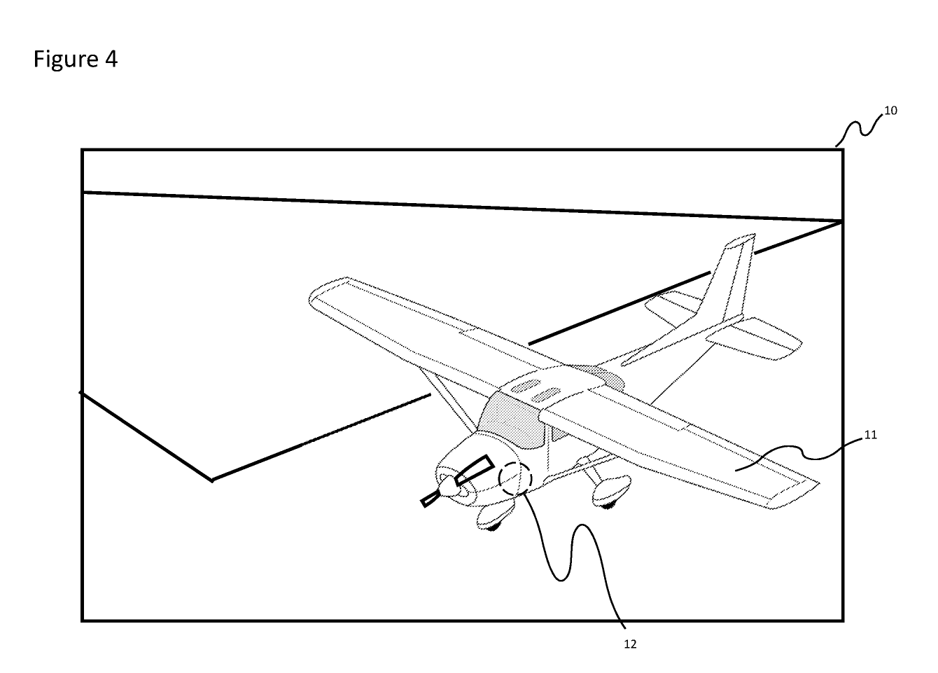

In FIG. 3 and FIG. 4, a video sequence plays which is streamed to a computing device (10) showing one object, in this example an airplane (11), which moves from the top right corner of the screen towards the center of the screen. The object and movement is for illustration purposes to show this method and process applied to create annotations, which we refer to in this invention also as Screen Tags. The video theme, objects, subjects, locations and their quantity, resolution and format may vary.

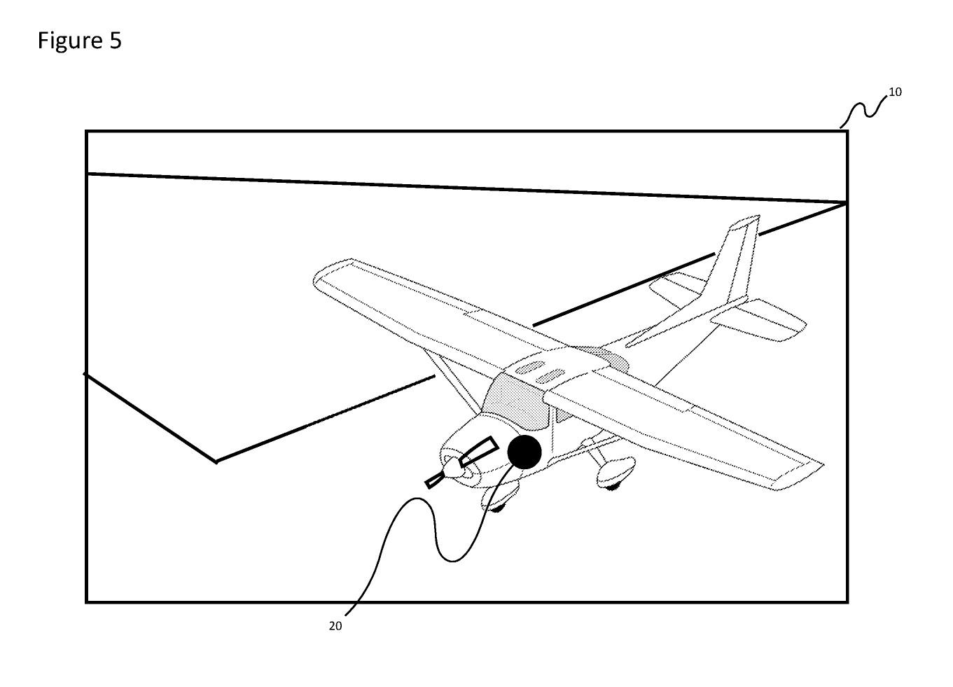

A user clicks on an object (11) at position (12) in a movie, where the object is the one to which the user wants to place or “attach” an annotation to. At the same time, or in another embodiment with a delay, the movie is paused or stopped. In this example, in FIG. 5, a user clicks on the side of the cowling of an airplane (20) to mark a location to place an annotation or Screen Tag. The Screen Tag serves as an anchor, placed by a user at a specific position (12) in a movie or image. This anchor or Screen Tag (20) is associated with the (x,y) coordinate of the position (12) and the frame number. In another embodiment, the Screen Tag (20) may also be associated with a time in the video.

Besides Screen Tags, which contain the annotation information, such as title, description, content, messages, URLs, as well as files of any type, there may also be Category Tags, to describe the category the annotation belongs to. In one embodiment, the Category Tags and the Screen Tags may also exist as a single tag with collapsible or variable windows, so that a user can access and interact with the information the user is interested in. In this example illustrated in FIGS. 3 to 18c there is one Screen Tag, which serves an anchor and a visual reference point rendered on the frames, a Category Tag, which is displayed on the bottom of the screen and a Descriptive Tag, which is an expanded view of the Category Tag. The Category Tag may be collapsible and/or expandable to minimize and maximize the view of the information. In another embodiment, not shown, the Screen Tag is an icon on screen depicting the type of content associated with that identified object. The Screen Tag can be clicked to reveal the associated type of content.

In this example as shown in FIG. 5, a user decides to attach an instruction video to the cowling in order to describe, for example, how to open the cowling to check the engine bay. The shape, color and form of the Screen Tag (20) may vary. Screen Tags (20) may be of different geometric shapes, colors or sizes, a logo, or text image, or any other graphical elements. Generally, the idea is to make the Screen Tag large enough so that it is noticed, but at the same time not so large as to obscure the movie. For different screen types the system may use icons of different scale. In another embodiment the Screen Tags (20) may enlarge on mouse over.

Once the user identifies the object of interest where the Screen Tag should be placed, the system will attempt to identify the region using what is known pixel region tracking. Pixel region tracking is used to determine whether the collection of pixels in proximity to the location identified by the user can be tracked for a predetermined length of, for example, four seconds. The system will determine whether the pixels are trackable over this period so that a Screen Tag can be placed at the identified position as it moves for the predetermined length of, for example, four seconds, after which the Screen Tag will vanish even if the object is still visible or reappears afterwards. The 4 second interval, for example, gives a user enough time to recognize the Screen Tag or Category Tag and click on it to access the annotation.

During playback the system will display the Screen Tag for a duration of, for example, four seconds and the user may in this time have sufficient time to click and explore the Screen Tag. If the user decides not to click on the Screen Tag, the system will make the Screen Tag invisible. In one embodiment the time of, for example, four seconds may be variable and dependent on the number of screen tags visible. The system may display individual Screen Tags longer when more Tags are visible in a frame sequence.

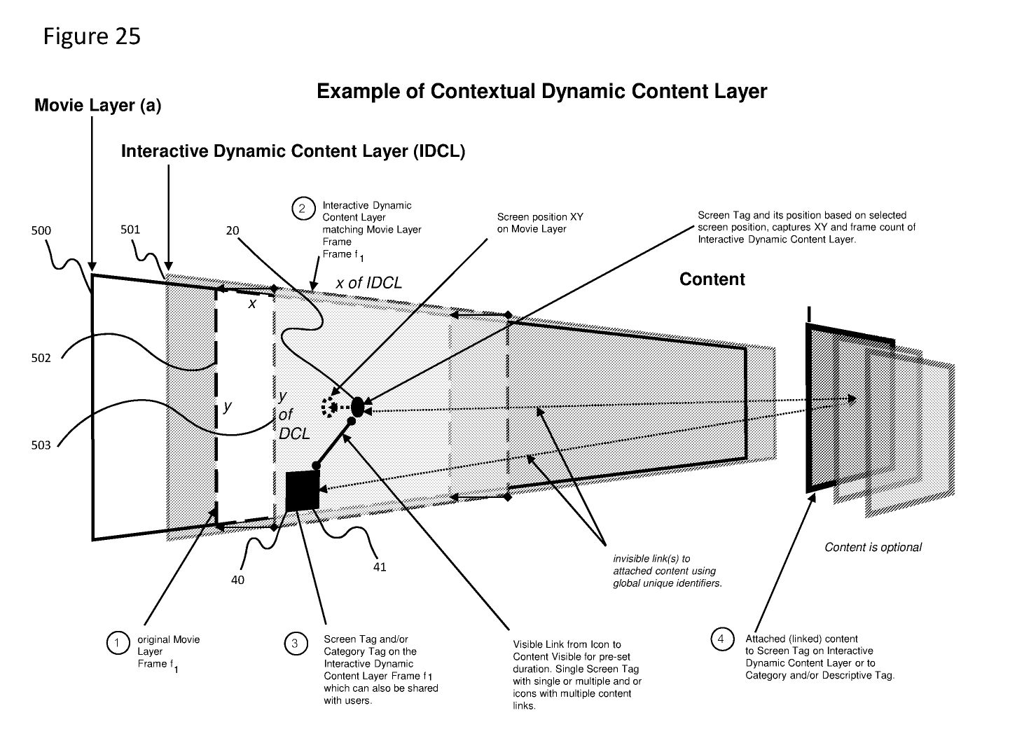

Because it is not possible to attach annotations directly to a movie when, e.g., the video content is hosted by a third party, one method is to create, for example, at least one invisible layer as shown in FIG. 25. This invisible layer matches the same number of frames and screen resolution as the underlying movie format and runs parallel with the movie. This invisible layer, which we call the Interactive Dynamic Content Layer (IDCL) (501), only contains the visible graphics, Category Tags and/or set of instructions and tells the system when and where a Screen Tag, annotations and information need to be placed. This Interactive Dynamic Content Layer (501) is the actual layer that pixel region tracking uses to detect the location of the user's clicking position (12) to create a Screen Tag. Because the Interactive Dynamic Content Layer does not contain the video images, the physical size of this layer is much smaller compared to the video layer (500).

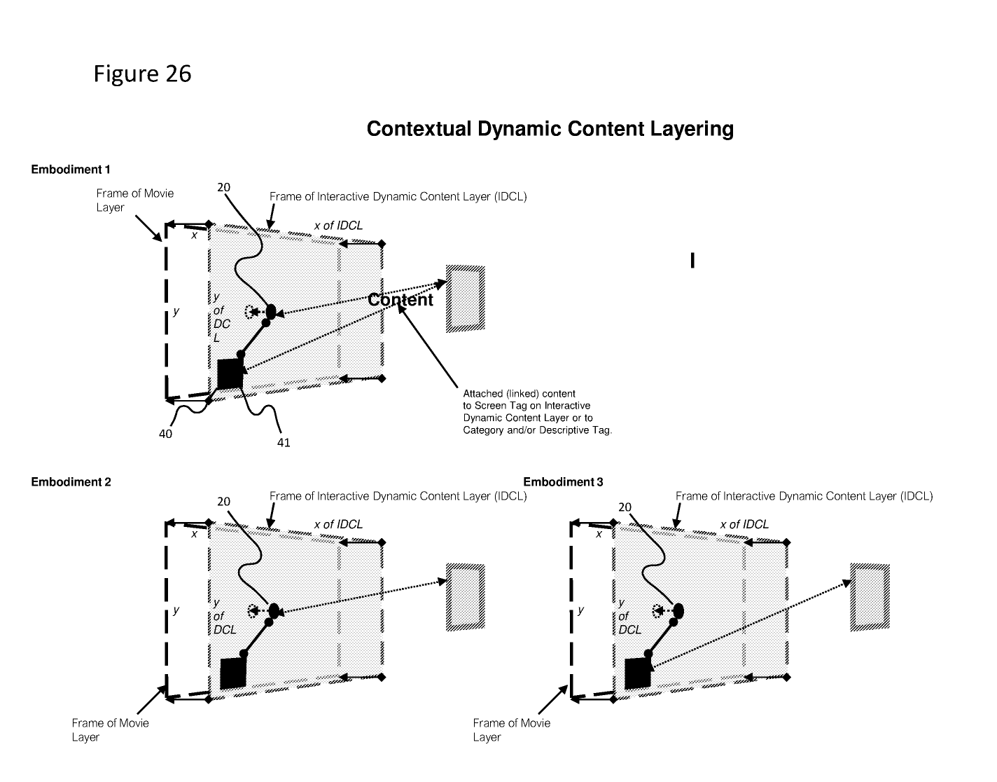

In another embodiment, this layer (501) may not physically exist, as shown in FIG. 26. Instead only the screen information and position, such as frame number, time and/or (x,y) position, is being captured and separately stored in a database. The associated graphics are retrieved and matched to each corresponding video frame or image when it becomes visible on screen. The system will for each corresponding frame render the designated Screen Tag as an overlay for the required duration and depending on user permission, and certain users or user groups may view different sets of Screen Tags even though they view the same content.

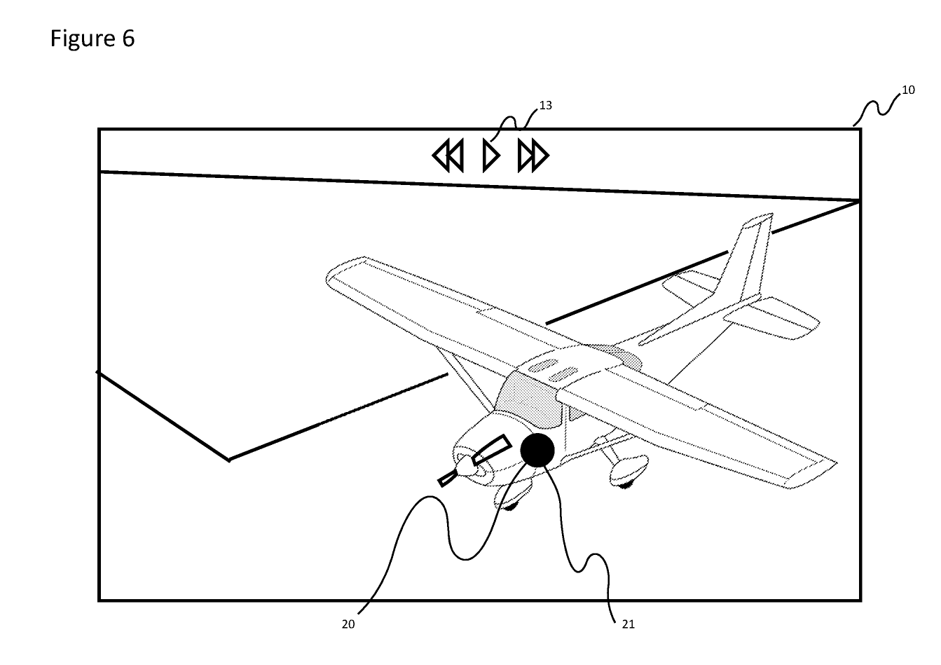

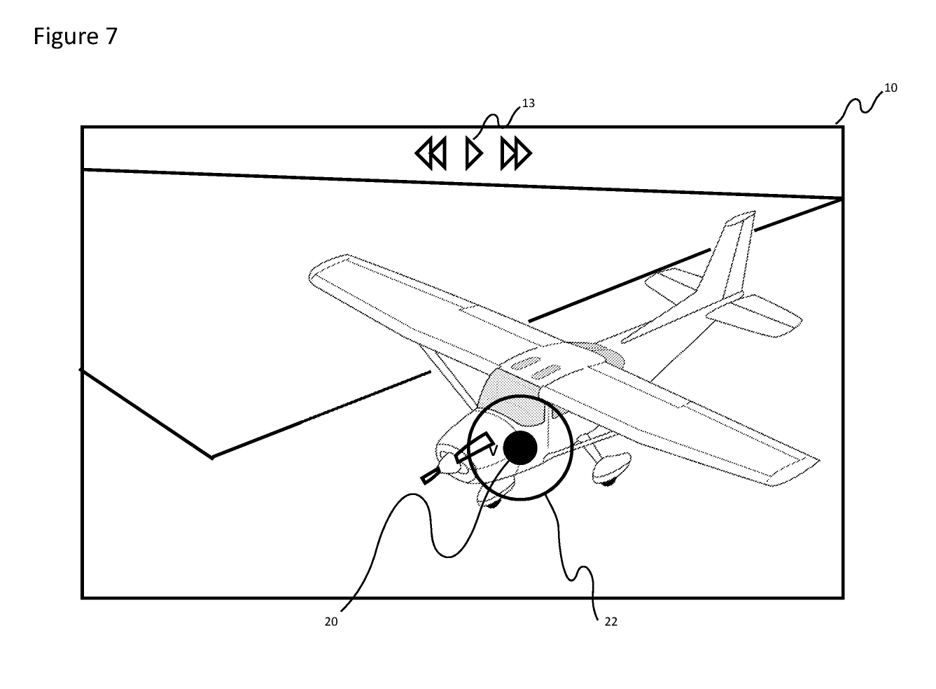

In one embodiment at least a play button, or other video control functions or buttons, are visible or are becoming visible (13) when a user clicks or interacts with the screen as shown in FIG. 6. The actual position of the movie control functions may be anywhere on screen. The video stops because it then allows a user to decide whether or not to delete or remove the Screen Tag (20) it created or open the screen tag. In case the user decides to delete the Screen Tag, the users can click the delete or remove button (22) of the Screen Tag as shown in FIG. 7. The position of the delete button is an example. It may also be at a different location or it might be a function in a menu. In addition, depending on authorizations the delete button may be inactive or hidden from view for specific users or user groups. In another embodiment, the users can invoke a cancel, delete or removal function by other means such as swiping across a screen with at least one finger or by other means. The idea is that a user has a method of removing his previous action of pointing at a location and inserting a Screen Tag, for whatever reason. In another embodiment the user can, by clicking on the video controls (13), continue playback in which case the system may show a message whether or not to remove the location of the Screen Tag (20) or not.

Once the user clicks on an object where the user wants to attach an annotation, the video stops or is paused and the pixel tracking process starts in order to determine whether or not the selected location is trackable or not.

The system may use one of several known methods for tracking the collection of pixels around the location where the user wants to insert the tag. These methods are, for example, a method by which video frames are compared to detect and track an object in motion. Another method is color comparison, where the system searches for color, shade differences. The system may decide not to use this method depending on light conditions and the quality of the video. Yet another method the system may use is markerless tracking, where the frame is converted to black and white to increase contrast. The slam-tracking method is another method that the system can use for tracking pixels corresponding to a selected portion of an object. This method uses reference points in high contrast images, which may be converted to black and white images, in order to detect and track an object. Besides these methods the system may use other methods for pixel region tracking.

Depending on the image, overall light conditions, image quality, object size and movement direction and other factors the system may determine by using a decision algorithm the optimum tracking method required to detect and track a group of pixels successfully for the duration of, for example, four seconds. In one embodiment the system will prioritize the methods by using the least amount of computing resources. In yet another embodiment, the decision for which method to use may actually change for every frame calculation. The system may use at least one method or use several methods and, or in sequence or any combination to determine whether or not a collection of pixels is trackable for a predetermined duration of, for example, four seconds.

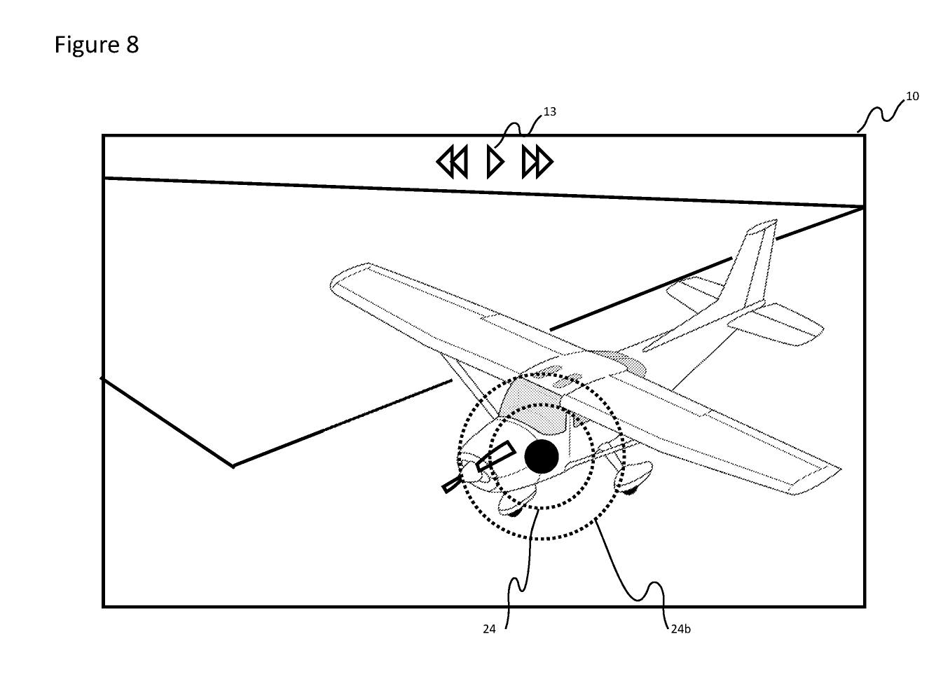

In one embodiment, as shown in FIG. 8, the system takes a predetermined area (24) of the image frame for the object tracking analysis to determine whether or not the pixels corresponding to the selected object at the clicked location is trackable for a predetermined duration of, for example, four seconds. By taking a specific area of a particular size instead of the entire image, the system will utilize a smaller area to successfully complete the calculations. This will help to optimize the overall object tracking calculation time especially when multiple calculations requests are performed for different users.

As a first step, which might be optional, at least two key frames, which might be predetermined key frames, are initially used to determine whether or not the set of pixels is trackable before the calculations are extended to include the additional frames required to track the pixels corresponding to the object for the duration of, for example, four seconds. This first analysis step, will help to determine not only which of the methods to utilize but also whether the object corresponding to the selected location is at all detectable and trackable. Should the system determine that the object is not trackable it will then either abort further calculations or it will make adjustments in the selection, or apply different a method, etc. At this point, the user might be prompted to again pick the location for the tag and the process will start over.

In this example, as shown in FIG. 8, the predetermined area is circular, however the shape of the selected area (24) may vary. The size or shape of the area (24) may be determined by the area required for the system to perform a successful calculation for a specific number of frame calculations. The optimum size may over time yield a specific percentage of positive identifications and therefore the system will utilize this method over any other method.

In the present invention the pixel tracking analysis is only required for identifying a specific element the user clicked on and for tracking the pixels corresponding to the selected area for the duration of, for example, four seconds.

Normally object tracking methods continuously track whatever is in appearing in view or moving or centered on a camera. This is, for example, the case when tracking a car from helicopter. In these applications it is required to lock onto a specific object and to track it for as long as it is in view. These methods are typically applied in a separate pre-processing or post-processing step prior to making these objects available for use or tracking.

However, in the present invention, object tracking is used differently. In the present invention, object tracking is used to detect and track a collection of pixels from a location selected by a user corresponding to an object for a predetermined time duration of, for example, four seconds, regardless of whether the object is afterwards still visible or not and regardless of this is a known object.

The idea is to use object tracking only for this brief duration so that the Screen Tag remains visible on the screen display long enough for a user to see it and to react with it. The time should not be too short, because a user cannot click on the Screen Tag if the tag disappears too quickly, and if it remains in view for too long it may obscure part of the video. The Screen Tag should be visible long enough for a user to notice it and to decide to whether or not to click and interact with it.

If the pixels have been successfully detected and tracked for, for example, four seconds then the tracking analysis is not required for this user selection after this four second interval, regardless of whether the object is still in view after that time period. However, if the pixels are not trackable within the predetermined time of, for example, four seconds the pixel tracking method may extend the time to include frames beyond the four second time. In addition the system may also take earlier frames for its calculation if the frames beyond the four second time interval do not yield a positive tracking result.

There are different ways how tracking calculations can be accomplished. One method is that the system starts out taking the first key frame where the user clicked on a location and then a second key frame within the 4 second interval, for example, to identify the clicked-on location. Or it might be several frames later or earlier, either predetermined or random. The system would start out by using the 1st frame and then it would then determine either the last frame of the required duration of, for example, around four seconds, or at least one, or several frame(s) earlier or later. It does not matter whether the exact time of four seconds is achieved, but it should be a period long enough for a user to see a Screen Tag and to interact with it when a video is running showing at least one Screen Tag.

In the case the video runs at a rate of, for example, 25 frames per second (fps), the last frame for the 4 second period would, for example, be frame number 100. Again, this can also be approximate, it could be frame 101, frame 102 or even frame 99, which are all close to the 4 second mark and not noticeable to the user. The system would analyze the 2nd key frame to determine if the selected pixel region is detectable and trackable or not. Should the region not be detectable then it would, for example, check the frame at the 3rd second, or near the 3rd second, to determine whether or not the region is detectable or not at that time. The system can take additional, earlier samples until it finds a frame where the object is detectable.

When the region is not detectable and the tracking software determines that the region is, for example, not trackable after 3 seconds, the system will determine the number of frames between the last frame where the region is detectable and the predetermined period for display of the associated Screen Tag. Then it would attempt to supply the missing frames by analyzing frames prior to the user selecting the location. If the missing frames to fulfill the four seconds time requirement cannot be supplied by the earlier frames, then the system can check if the frames required for a 4 second interval can be found in frames appearing after the previously-calculated end frame. In this case, the system will check if the selected pixel region reappears and is visible for sufficient time to meet the 4 second interval. The system might, for example, only check the next 30 seconds of frames to determine if the frames contain the identified pixels. Then the system might present the findings to the user to find out if the user accepts this new location closest to the user's initial location for a Screen Tag.

In another embodiment, the system can check the frames in sequence. It will start with the frame that the user clicked on. In another embodiment the calculation can also start at the 100th frame and calculate backward. In another embodiment the system will check the key frames in sequence. For example, the system would take the key frames 1, 20, 40, 60, 80 and 100 (25 fps for four seconds) for analysis to determine whether the selected pixels, whether in motion or static, are detectable and trackable. Or the system could take, for example, a random sequence 1, 19, 42, 59, 80, and 98 where the key frames are unevenly spaced out. Or, in another embodiment the system will take a random selection of these numbers. In yet another embodiment the system will start from either end using frame 1 and 98, for example, followed by 19 and 80, and so forth. The idea is to analyze only the key frames that are more or less evenly spaced out to determine whether or not the selection is trackable or detectable. If the selection is trackable, using these key frames within the required time of, for example, four seconds, then the selection is likely trackable in all the remaining frames in that interval of, for example, four seconds. If the detection and tracking of the selection is positive, the system will create a Screen Tag at the location of the identified location and track it for the duration of, for example, four seconds. In another embodiment, the system may determine, using an algorithm, to create a Screen Tag at the identified location and track it for the duration of, for example, four seconds when a specified minimum number or percentage of frames contain a valid selection.

After this predetermined time, of for example four seconds, the Screen Tag (20) disappears from view even though the selected region (12) may still be in view (FIGS. 4 and 5). The idea is to minimize the time a Screen Tag is visible on screen so that it does not obscure and interfere with the viewing experience. In another embodiment the system may at specific intervals, when the selected region reappears, redisplay the Screen Tag.

In order to shorten the overall calculation process and make it more efficient, the system can in one embodiment, as previously mentioned, use a predetermined frame selection (24) and use this for the region tracking analysis rather than taking the entire frame selection as shown in FIG. 8. If the system is either unable to identify the region using the predetermined area (24), or the system is unable to positively track the identified selection for the remaining predetermined duration of time, for example, four seconds, the system may increase the size of the area to be analyzed (24b) by a specific amount and then repeat the calculations to determine whether or not the selection can be tracked in the remaining frames for the predetermined duration of, for example, four seconds (FIG. 8). These steps may be repeated. The reason for starting the calculation with a smaller area (24) and then increasing the area (24b) in steps and repeating the calculation with a larger area is to reduce the required calculation time.

Generally, the tracking calculations are performed on the server but in one embodiment the tracking calculations may also be performed, in part or as a whole, on a software client.

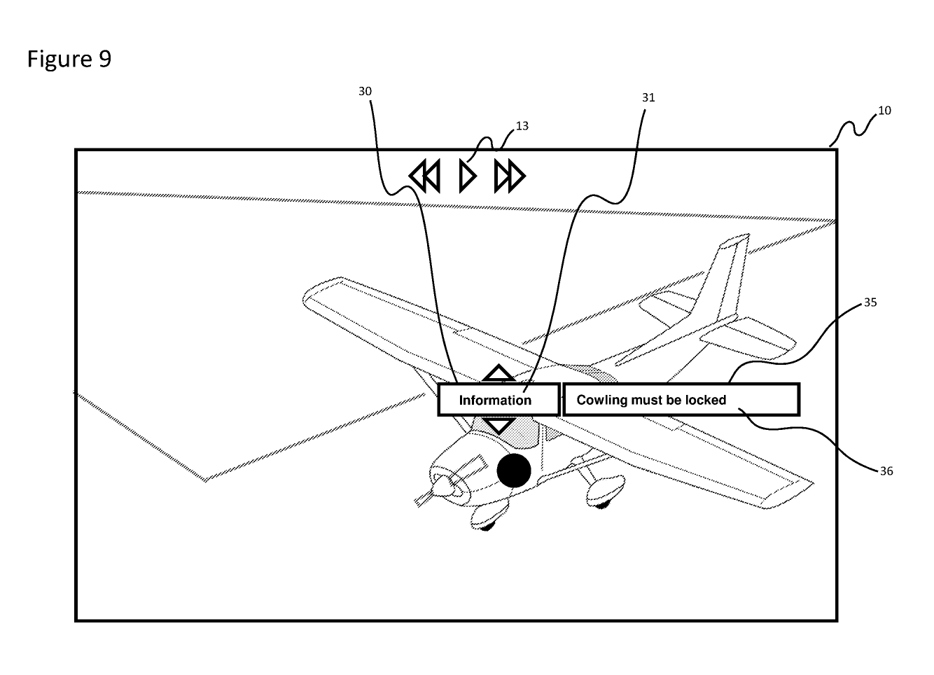

When the selection has been identified for the predetermined duration of, for example, four seconds, the system will display at least one Tag Window (30, 35), where a user can select from or type in information related to the Screen Tag that is being created as shown in FIG. 9. These can be separate windows belonging to one or more Tags. In another embodiment, the user may select a type of icon that depicts the type of category that the annotation belongs to.

In the example shown in FIG. 9 the system will show a Tag Container (30) where the user can select a Tag Category (31), the position of which may vary. The Tag Category (30) may be predefined, either by the content author or the system administrator or it may be user defined. In one embodiment the container (30) and category (31) may be one unit.

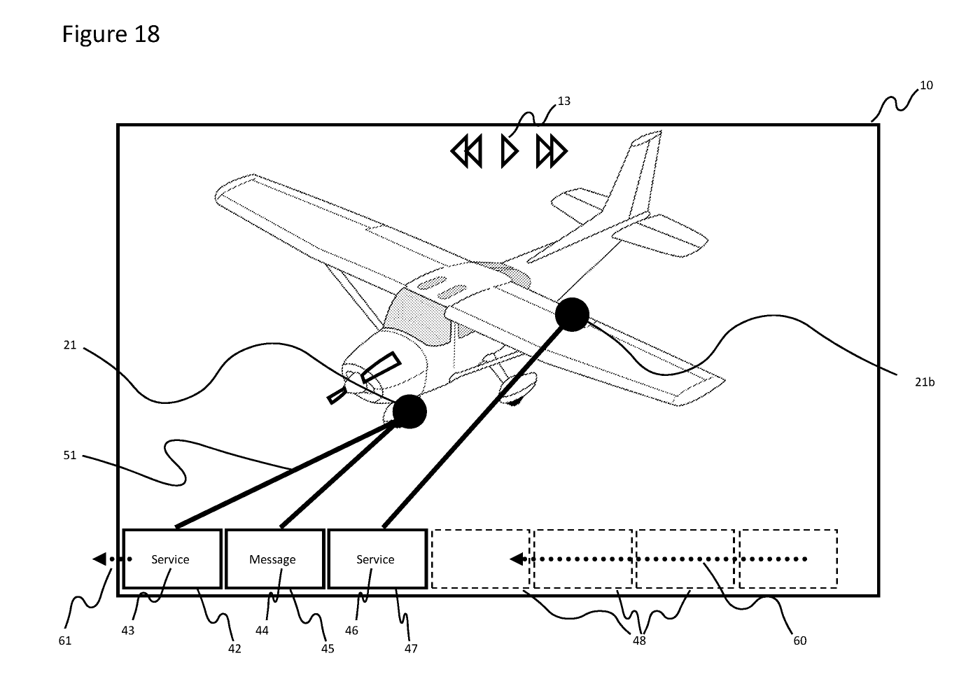

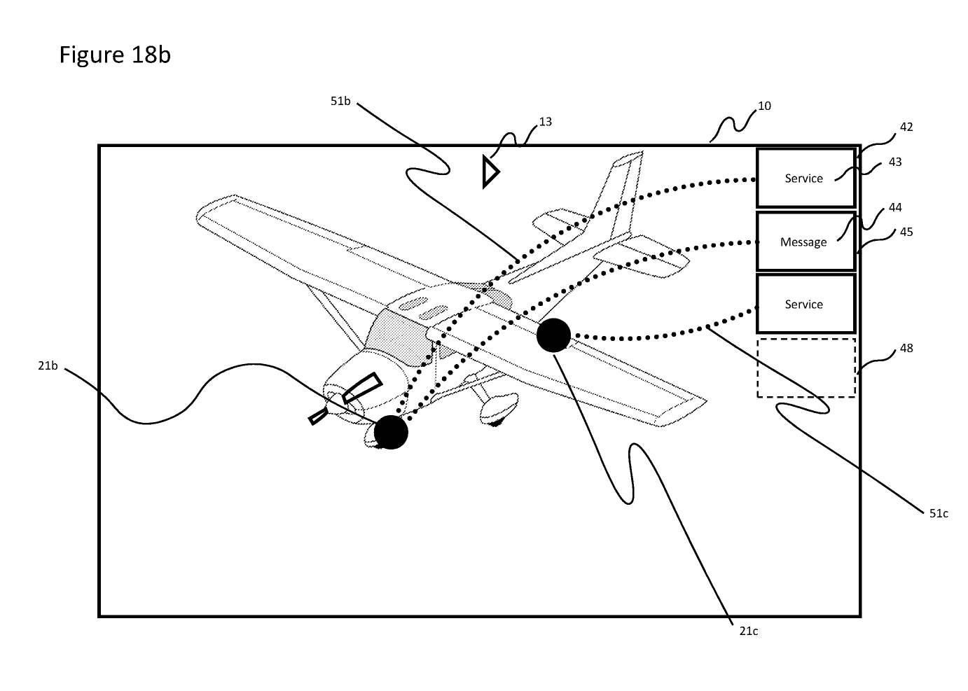

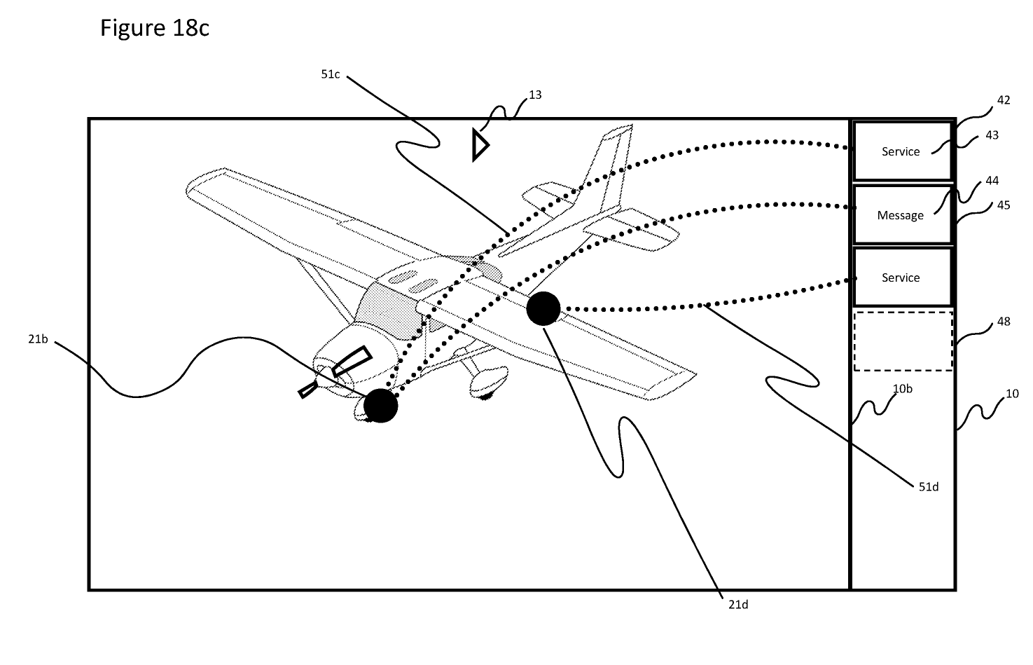

The idea is to offer a method of grouping Screen Tags shown on screen so that they can be displayed, filtered, searched by the viewer or hidden by the content administrator. A category will help to define the category that a Screen Tag belongs to. For example, there may be a Video Tag that then allows the user to upload or record a video which is then associated to that object that was previously identified by the object tracking for the period of four seconds. In addition, all Tags used can be activated and made visible for specific users or user groups viewing the same video for example. In another embodiment users can be notified when new Screen Tags to a specific category appear. Similarly to emails, newly added Screen Tags can, for example, be separately listed and/or marked as new or unviewed. A user can, for example, click on a Screen Tag and it will then open the respective video and skip to the frame where the Screen Tag has been attached (FIGS. 18b and 18c).

In one embodiment, the Category Tags can have specific subject names, or for example, logos, icons, or other kinds of information, with different shapes or colors. In the present example the user selects from the dropdown the “information” topic in the Category Tag (31) (FIG. 9). Alternatively the title of the annotation can serve as a Category Tag. Users may in another embodiment decide which information is displayed for the Category Tag by selecting, for example, an icon or a name category (31) from a dropdown or popup menu (30). The user can also enter a title (36) as a Title of the Description Tag (35). Again, both the Category and Description Tags may exist in one embodiment as one single tag with all required information. That single tag may be collapsible and display specific information when the video is played. When clicking on the tag the user can access the additional information associated with that tag. In another embodiment the Screen Tag, Category and Descriptive Tag may exist as one Tag.

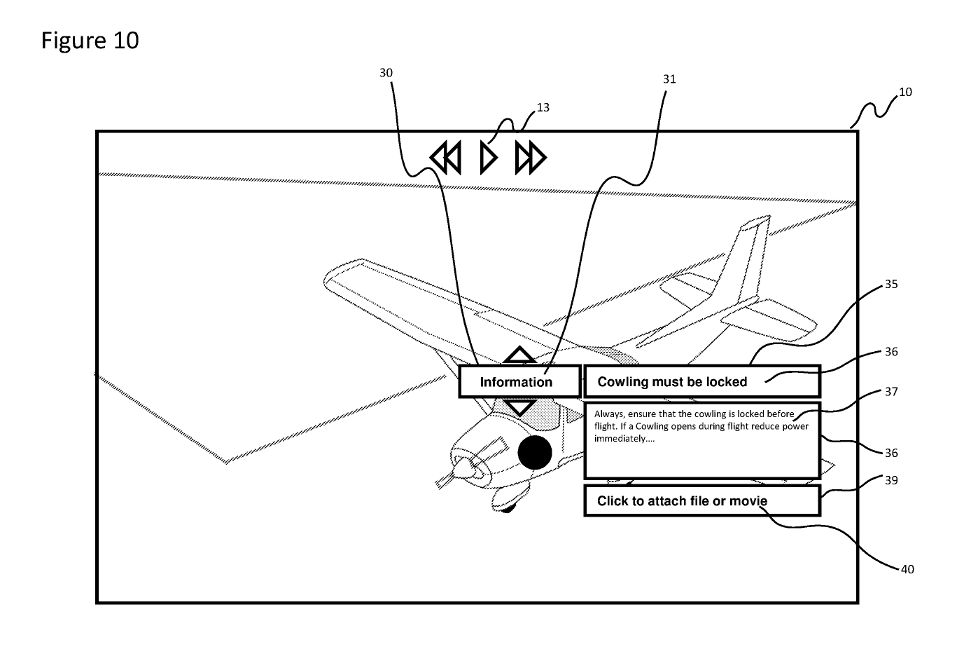

In another embodiment, as shown in FIG. 10, a user might add a description (37) or add, or link a file, or a video (40) or other data to the Description Tag, which in this embodiment consists of collapsible containers, windows or fields (35, 36, 39). The container for content (30) to describe the Description Tag may exist as a separate tag, such as a Container Tag, or be part of the Description Tag and be visible on demand by means of collapsing windows, containers for example.

When adding, for example, a file or video, the video is uploaded to the server and stored for streaming In one embodiment the system may convert the file prior to upload to a specific format or formats in order to optimize the performance of this service. In another embodiment the content may be stored locally. Prior to uploading the video, image or other file may be checked for format type, size and other criteria to meet specific requirements before being uploaded. The file may also be converted and/or optimized, using file compression, codec conversion, file optimization or other means, prior to upload by methods known, or before being stored locally for access by the system.

The Tag Containers (30, 35, 36, 39) may be a single container with separate spaces to add the information, or individual containers, which may or may not be collapsible, as shown in this example in FIG. 10. The Tag Container or Containers may appear anywhere on screen. When authorized, users can add content in the Tag Containers, or the content can be removed or deleted. In one embodiment, a delete button may appear on the Screen Tag, or delete buttons also appear on/on top/next or near the individual containers (30,35,36,39,) (not shown), so that the user can delete the information or the Screen Tag, as shown in FIG. 10. In another embodiment the delete function may be part of a menu.

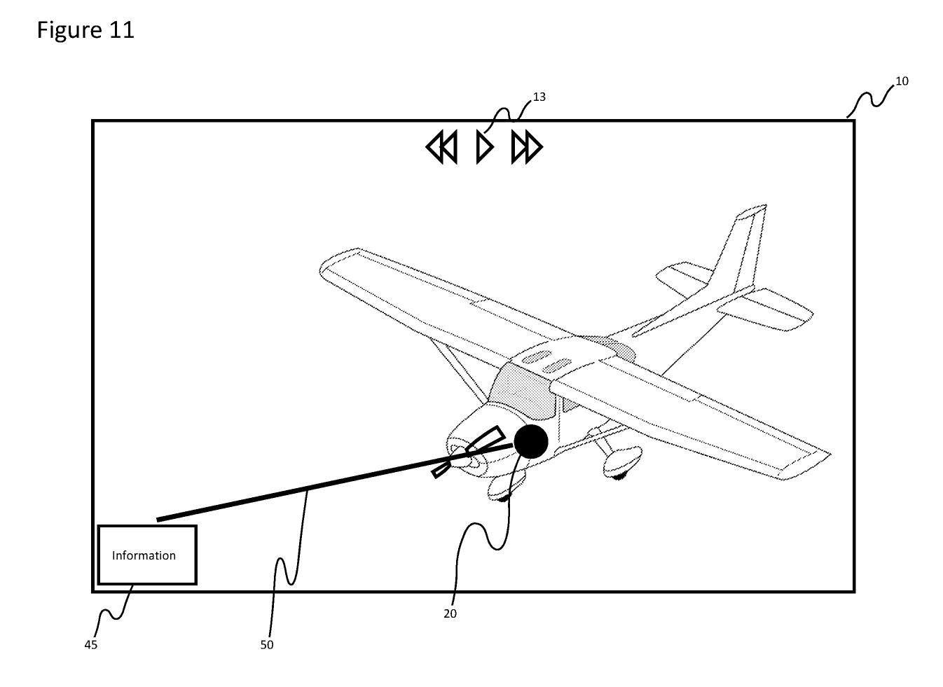

Once the information in the Tag(s) has been added, the system will in one embodiment display at least one Tag Container (45) visible at a specific location on screen as shown in FIG. 11. The category Tag container (45) is placed on the bottom of the screen so that it does not obscure the video viewing experience. The idea is to show a user that in a particular video sequence there are Screen Tags, which can be viewed when they are clicked on. In one embodiment the Tag (20) is shown and the Tag Container (45) and all information is displayed when the Tag (20) has been selected or clicked during playback in the corresponding frames.

In another embodiment, the viewer may activate or deactivate the Screen Tags (45) when viewing is required without Screen Tag information. In this example, the position of the Tag Container (45) FIG. 11, is at the bottom of the screen. The location and the size of the Tag Container may be different and may vary as shown in FIGS. 18b and 18c. The idea is to leave enough space to view the video. The Tag Container may display any information. This may be predetermined based on the settings. In this example the Tag Container shows the Tag Category labeled ‘Information’. The Tag Containers may in another embodiment be shown in a list view in a separate window.

In another embodiment, the system also displays a link (50) between the Tag Container (45). In this example, as shown in FIG. 11, the Category Tag, and the Screen Tag (20) are linked by a line (50), which may be of any size, shape, type or color. This link (50) will in one embodiment be visible for as long as either the Screen Tag (20) or the Tag Container (45) are visible. In the present example we assume this to be four seconds. If the Screen Tag disappears from view after the predetermined time of, for example, four seconds, then the link (50) will also disappear, leaving the Tag Container visible for another specified time.

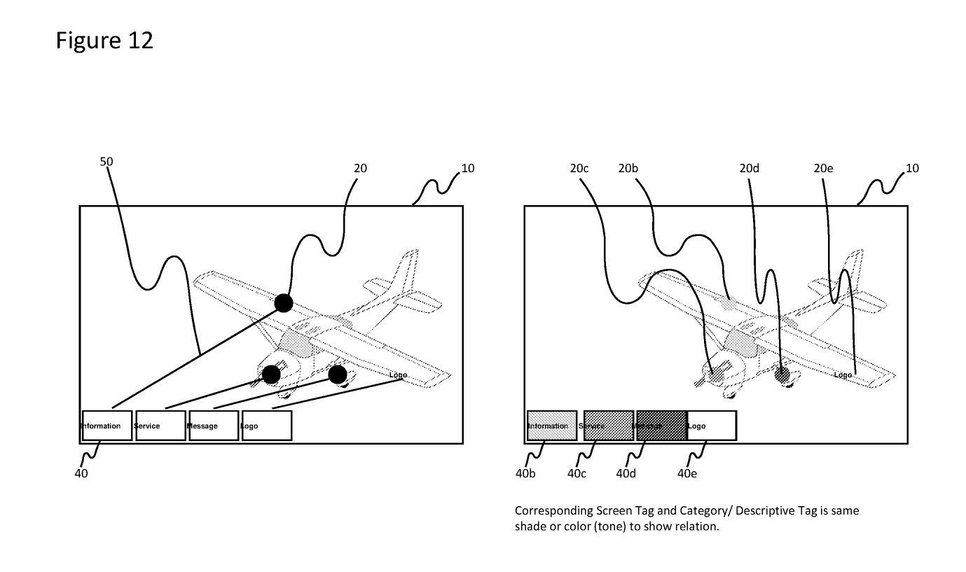

In another embodiment, the Link (50) can also be generated by giving both the Tag Container and the corresponding Screen Tag (20) the same color or shape as shown in FIG. 12. In yet another embodiment the corresponding Screen Tag and its Category Tag, or vice versa, may enlarge on mouseover revealing the selected corresponding tag. FIG. 12 shows that in a different embodiment corresponding Screen Tags (20, 20b, 20c, 20d, 20e) and Tag Containers (40, 40b, 40c, 40d, 40e) can each have matching colors, patterns, shapes, icons, logo or outlines instead of having a physical link (50) visually connecting the Tag Containers with the Screen Tags. In another embodiment, numbers, colors, icons, shapes or letters can be used to match the corresponding Tag Container and Screen Tag.

In one embodiment, as shown in FIG. 12, a physical link (50) is not necessary, which is preferable especially when multiple screen tags are visible at any time. The idea is to visually link the Screen Tag (20) with the Tag Container (45) on screen, so that users can identify which Tag Container (45) is linked to which screen Tag (20). As mentioned, this may be the case when there are multiple Tag Containers in view. During video playback, the Screen Tag (20) will follow the identified object (12) and if a Link (50) is used it will remain connected to the Tag Container (45) and the Screen Tag (20). After the predetermined time elapses the Screen Tag (20) and the link (50), if used, will disappear from view and the Tag Container (45) remains visible for further predetermined time. In one embodiment any Tag Container (40, 42), which may include the corresponding Screen Tags (20), are highlighted or marked otherwise when the corresponding Frame with the Screen Tag(s) (20) appear(s) in view. In one embodiment, the Tag Container (45) will also disappear from view concurrently with the Screen Tag (20). Once the Tag Container (45) has been created and a Link (50) is created, the video may either automatically continue playback, or the video resumes when the user presses, for example, a video control button (13).

In one embodiment it may be possible to have multiple Tag Containers (42, 45) linked to one Screen Tag (20) as shown in FIG. 18. In this embodiment it shows a single Screen Tag 21 with two links connecting to two different Category Tags. Note that this may also work without a link (51) by using similar shades, icons, or colors as described earlier. By using one Screen Tag for multiple Category Tags it reduces the requirement of having multiple Screen Tags on screen reducing clutter. In another embodiment Tag Containers may be linked or chained to more than one position in a video. This could either be the same cluster of pixels reappearing at a different frame location or another cluster of pixels that the user clicked on that was previously detected. This can be particularly helpful when certain information needs to be repeatedly mentioned in a video or other videos.

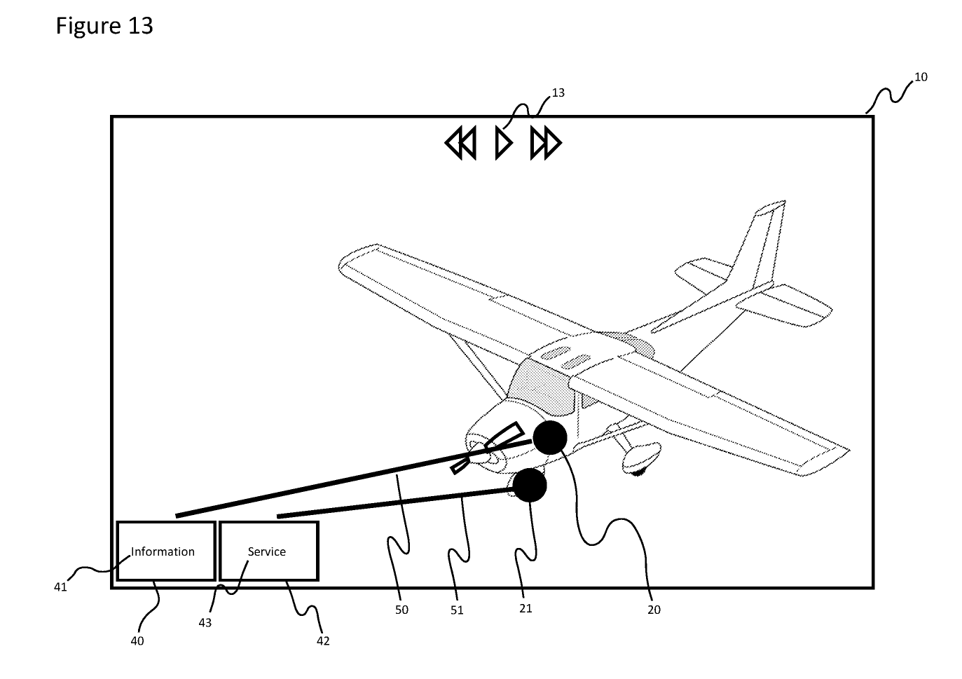

FIG. 13 shows a second Screen Tag (21) with a Link (51) to its corresponding Tag Container (42) pointing to a different element or part (21), which has been positively identified for a predetermined time of, for example, four seconds. The Tag Container (42), with another Category called Service (43) is shown next to the existing Tag Container (40) labeled Information (41). Any further Screen Tags appearing in view will position the corresponding Tag Containers in sequence, in this example, at the bottom of the screen display (10). The Tag Containers may also be positioned in other parts of the screen as mentioned earlier.

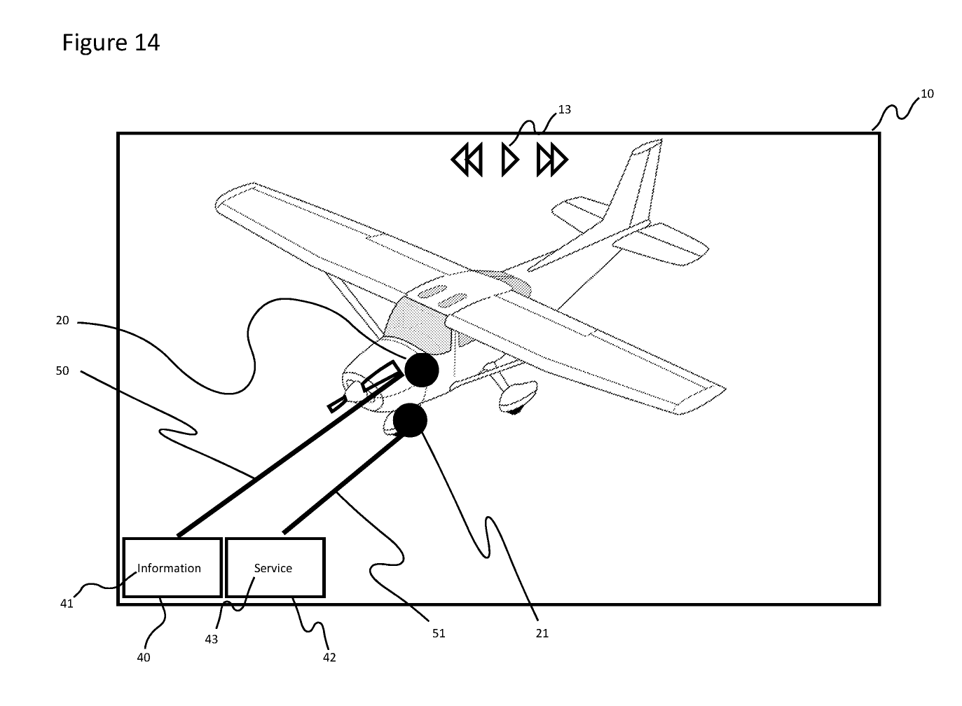

As the video plays back, the Tag Containers (42) will remain static while the Screen Tags will follow the positively identified parts and the Links (50, 51), if used, will remain connected with the Tag Containers (40,42) for a predetermined time of, for example, four seconds as shown in FIG. 14. In another embodiment where only Screen Tags are used, the clickable Screen Tags (20) will follow their positively identified elements for a predetermined time of, for example, four seconds and will then disappear unless a user decides to click on them, which will cause the video to pause to reveal the information of the tag.

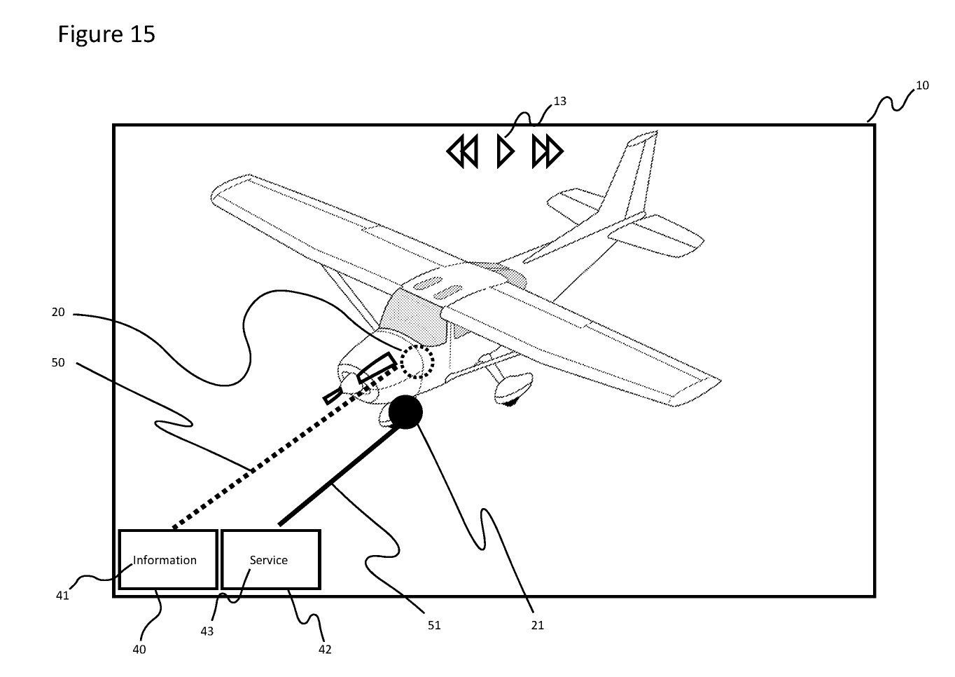

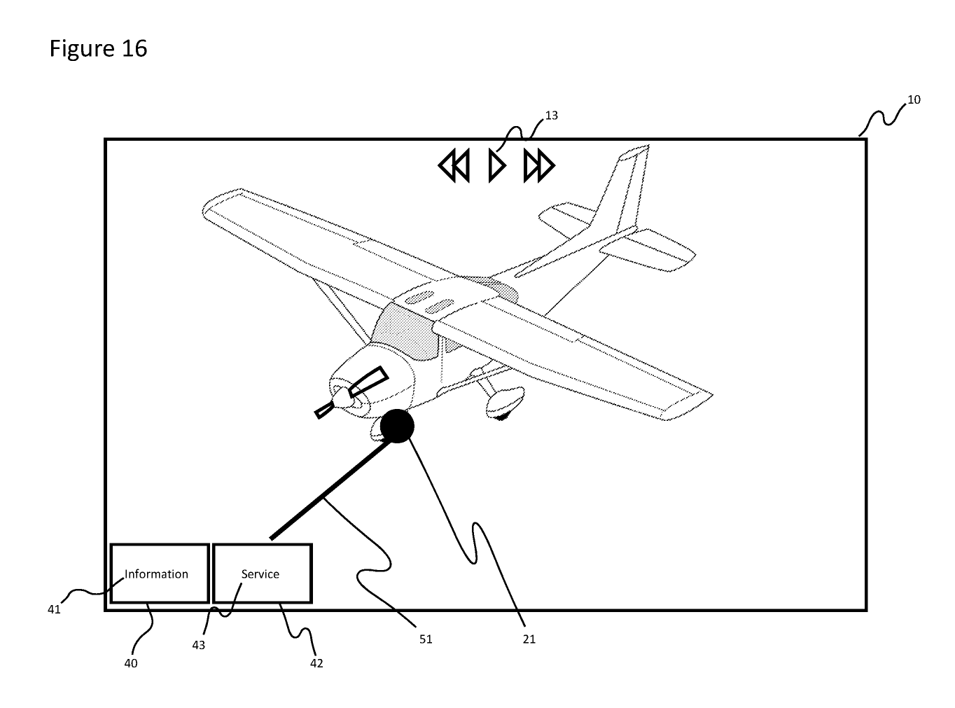

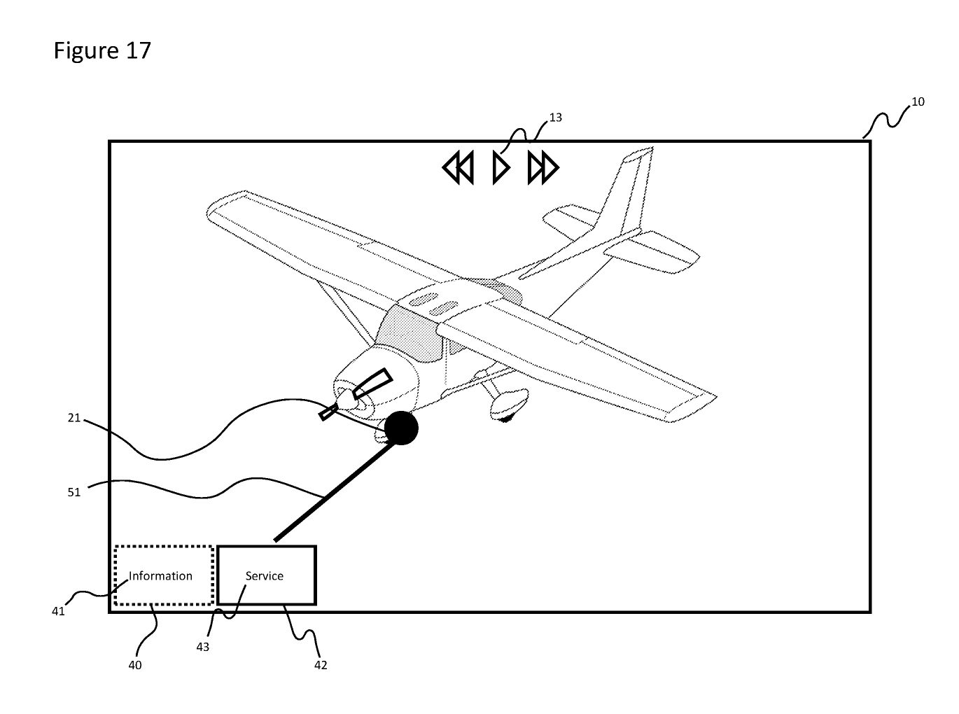

The Screen Tag (20) will remain in view for a predetermined time of, for example, four seconds, after which the Screen Tag (20) and the Link (50), if used, will disappear from view. In one embodiment, the corresponding Tag Container (40) will remain in view for a longer predefined period as shown in FIG. 15 and FIG. 16. After some predetermined time, the Tag Container (40) will also disappear as shown in FIG. 17. The following Tag Container (42) and all continuing Tag Containers (45) and (46) will shift over by one position, making room for more Tag Containers that will follow or appear. In one embodiment the Tags will be listed separately and independently of the video shown. During playback the corresponding video tags that appear on screen will be highlighted. The user may at any time click on the Tag, which will then skip to the frame with the corresponding tag.

In one embodiment, as shown in FIG. 18, the Tag Containers (42) and (45) have shifted to the left and a new Tag Container (47) appears in view with the Screen Tag (21b). The spaces (48) as shown on the bottom of the screen are reserved Tag Containers for any of the following Screen Tags appearing in the video. These spaces may or may not be visible and are shown to explain the method. In this embodiment the direction of new Screen Tags appearing would be from right to left, as shown by the arrow (60), which is an example to show direction. Alternatively, the direction could also be the opposite way or from top down or bottom up. Again, the positions of the Tag Containers are exemplary as are their sizes, shapes, logo, icons, and colors, which may actually vary. In one embodiment, the Category Tags on the bottom of the screen may actually appear longer than the Screen Tags, which are in view for, for example, four seconds. The Category Tags can stay for either a predetermined time of, for example, 15 seconds or they remain in view for as long as there is space. It would follow the first in last out method. FIG. 18b and FIG. 18c show the position of the Tag Containers on the right side of the screen (42, 45).

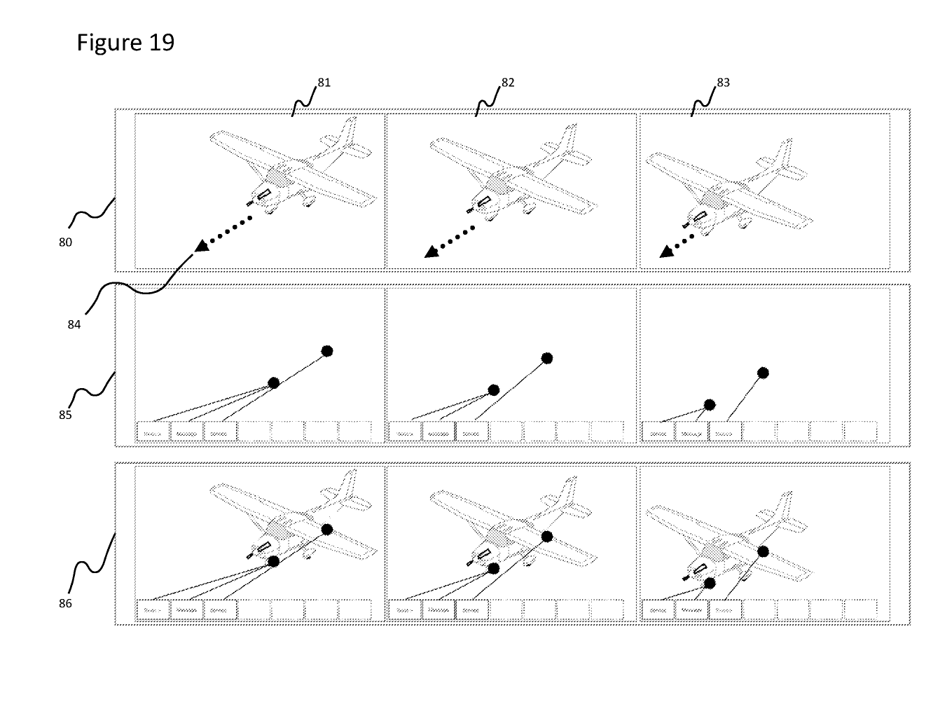

FIG. 19 shows a method of displaying the video and the associated tags that have been created. In this embodiment, the video and the graphical elements are separated, similar to a layer as described above in connection with FIG. 25. This embodiment (FIG. 19) illustrates as an example, a video (80) showing three frames (81,82 and 83) from a video sequence, where an airplane travels from to top right to the bottom left of the screen (84). Based on the video's frame count, time (optional), frame rate and screen resolution, or any combination of these, a separate interactive layer (85) is created that matches the exact same frame of the video. This interactive Dynamic Content layer (85), as described above in connection with FIG. 25, contains all the Tag Containers, Links and Screen Tags and their positions relative to the video (80). The video will show as an interactive video (86) with both the interactive Dynamic Content Layer (501) and the video layer (80) (500). For this it may be required to run a special software, plug-in, website, or player to display the video with the interactive graphics as an overlay layer. Without this the video will run on an existing basic video without presenting the interactive Dynamic Content layer (85) (501).

In yet another embodiment the system plays back the video and inserts at the required positions of each frame the Screen Tag graphics and associated information. The information and graphics is retrieved from at least one database as described earlier.

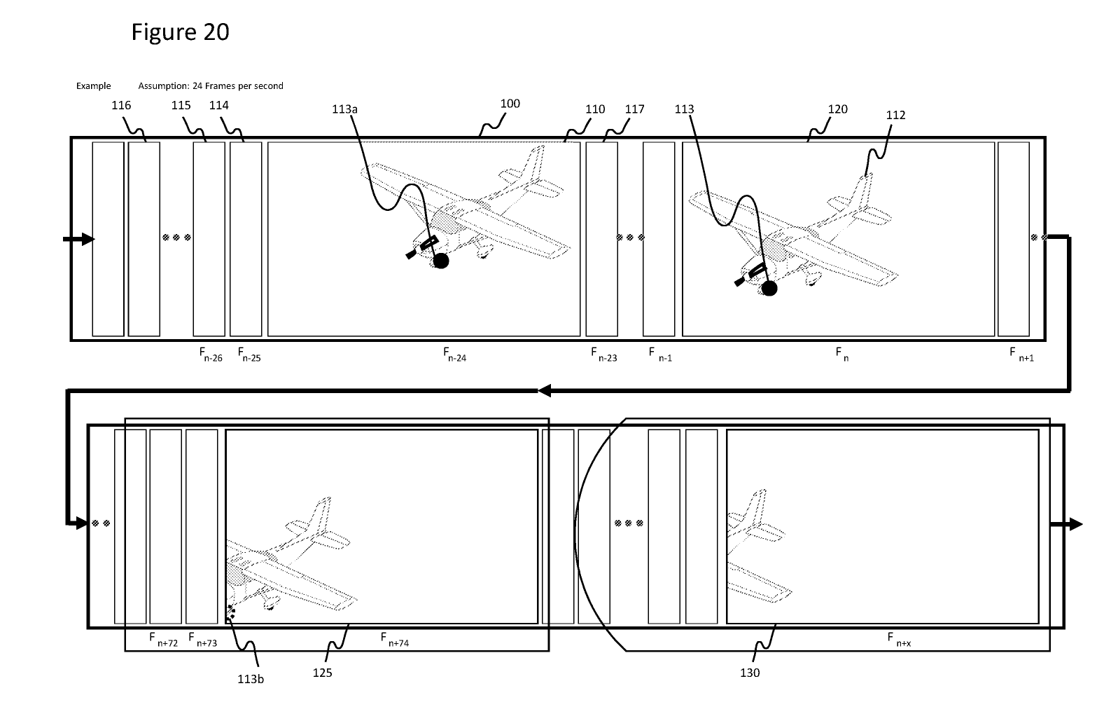

The next FIG. 20 illustrates more clearly how the system, or element tracking software, handles for example, a part (112) with an element (113) that it cannot successfully track for a predetermined duration of, for example, four seconds starting from Frame (120). This might be the case because the element at the desired location (113) the user identified, for example, cannot be tracked for the four seconds required for the system to create the Screen Tag (113) at the 4th second frame position (130). Alternatively, the part could, for example, become obscured by other elements for whatever reason. In this scenario, as described in FIG. 20, the region tracking software would calculate the missing number of frames to meet the 4 second requirement, for example and determine the last frame (125) where the Screen Tag was still visible (113b). From that point the region tracking software calculates backwards the four seconds of frames required and determines that the frame (100) is the start frame required where the Screen Tag should be created to fulfill the four second requirement. If a positive tracking of the element can be maintained, the system would then insert the Screen Tag (113a) and create the Tag Container and the Link (50), if used, as described earlier. In another embodiment, the system would calculate the start Frame number by subtracting the still required missing frames from the frame Fn (120) to derive to the start frame (100). There may also be other methods to calculate the required frame number required.

Alternatively, in another embodiment, the system may also determine whether the element reappears after the predetermined time of, for example four seconds. The system may in such a scenario analyze further key frames within a predefined time, for example, 30 seconds, to determine whether or not this element reappears for the desired time of, for example, four seconds. If this is the case the system may inform the user that a new section has been found where the element appears, in which case the users can check if the detected sequence is suitable for a Screen Tag.

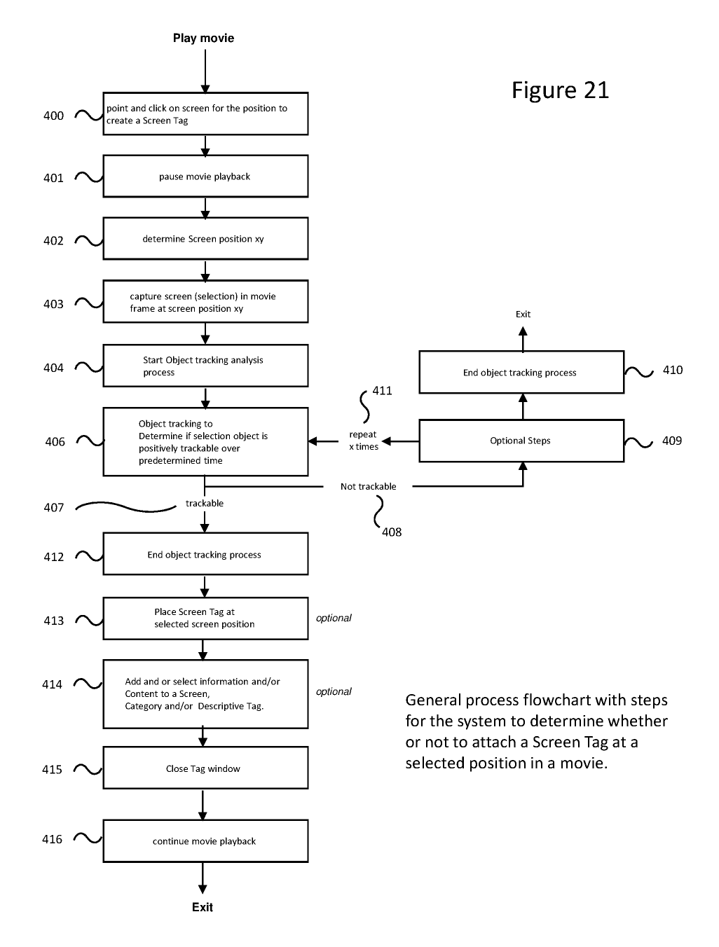

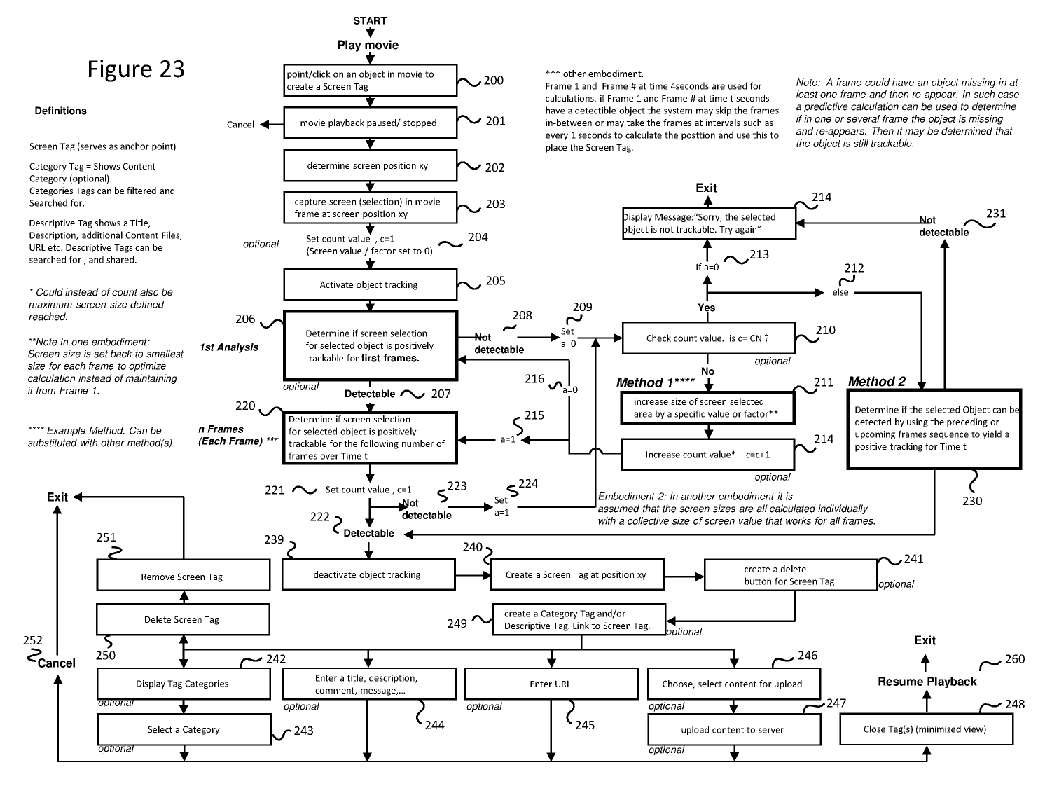

FIG. 21 outlines the steps for one embodiment of the element tracking process. The process described in FIG. 21 is an example and the process may slightly differ. FIG. 23 will describe this process later as an example with far greater detail.

Regarding FIG. 21 a video is playing in a software application (400) as described earlier. The user clicks on a location in the video generally corresponding to an object and consisting of a collection of pixels, which does not yet have a screen tag associated with that element. This action pauses or stops the video playback (401).

The software then analyzes the position by capturing the (x,y) coordinates of the location that the user clicked on (402). While in one embodiment, a specific screen selection is used for the calculation, in another embodiment the entire frame is used for element tracking analysis (403) as mentioned earlier.

At this point the element tracking software starts the process to determine whether it can track the selected part for the duration of, for example, four seconds (404). The element tracking calculation is only used from this point on for the duration of, for example, four seconds and it may in parallel process tracking requests for other parts. For this particular calculation the element tracking is activated (404) to calculate for this particular frame the part. Unlike traditional object tracking software like, for example, in security or military applications which require continuous analysis, in this invention the calculations for each element are limited to, for example, four seconds and additional frame calculations if the element was not trackable for that period. In one embodiment the analysis for this position is captured by taking the (x,y) coordinates of the screen position (20) of the frame (503) in the Interactive Dynamic Content Layer as shown in FIG. 26. Again, the IDCL may or not be a physical layer where this information is stored for each frame as described above in connection with FIG. 25.

The system will take different frames as mentioned before, within the predetermined time of, for example, four seconds (and may as mentioned deviate from this and pick frames beyond the 4 second time if the object is not trackable) in order to determine whether the object is trackable over the predetermined period of, for example, four seconds. This step may be preceded as described earlier by an optional first analysis, to determine whether or not an object can be positively identified and tracked.

Assuming that the element has been identified and is trackable (407) using the methods described earlier the tracking process is completed (412) for that particular part, the system will then place a Screen Tag (413) for the duration of four seconds. This might as described earlier be either at the position the user clicked on for the duration of four seconds or approximately for four seconds. Or it might suggest to place a marker at a different frame, as described earlier, because the element could not be identified for whatever reason.

Should the element tracking not be able to identify or track the part (408), the system will choose a different method or adjust the method accordingly for each calculation (409). Should the calculations exceed a specific threshold (411) the system may end the element tracking process (410) and inform the user that the selected part cannot be identified and/or tracked.

Once the Screen Tag has been placed at the location (413) and the user filled out the Description, added files or other information, and/or selected or added the Category Tag information the window can be closed (414). In addition, the entries made and the marker can be deleted at any time. Once the window has been closed (415) the video continues playback (416) automatically, or the user may prompt the video to playback by clicking on the video controls (FIG. 23).

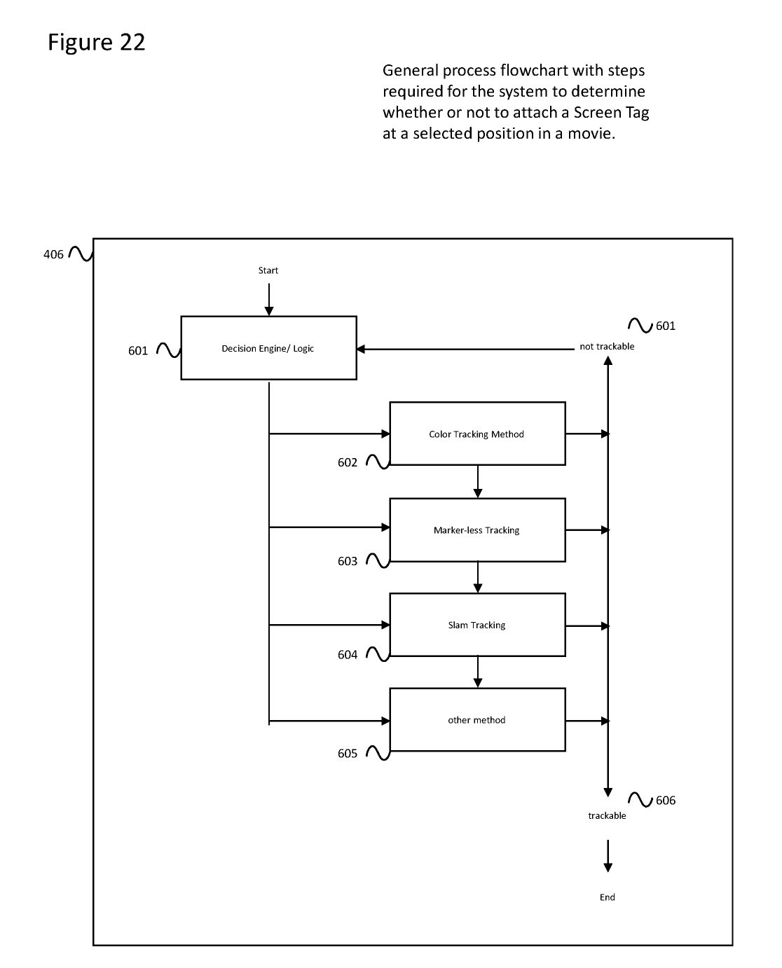

FIG. 22 shows a diagram showing the process that the element tracking may follow (406) by applying at least one method to determine whether or not a part is trackable (606) for a predetermined time of, for example, four seconds. In this example an algorithm or decision logic (601) determines which of the methods the element tracking will use to track the selected element. The element tracking may pick any method (602, 603, 604) or other methods (605) as shown in this example and repeat the method by making necessary adjustments to the actual method if the selected part is not trackable (601).

FIG. 23 describes in more detail using a flow chart the method or process of when and how a Screen Tag is placed at a selected position in a video. Placing a Screen Tag in a video frame requires certain steps. Many different Screen Tags can be created by different users and the number of Screen Tags visible in a particular frame is generally not limited. However, to reduce the number of Screen Tags, so that the video is not obscured, Screen Tags can be filtered or they can be shown based on, for example, the times when they were added. The methods for filtering or displaying Screen Tags may vary and can be set, for example, in user preferences.

To place or create a Screen Tag a user will play, for example, a video as shown in FIG. 23. The user would then point and click on an element in a video in order to create and associate a Screen Tag associated with that element (200). When the user clicks, or with slight delay, the video will pause or stop and be ready for playback when prompted by the user (201). At this point the screen position ((x,y) coordinates) of the clicked position is captured and then processed either locally or by the server in the backend (202). With the help of the screen position, the frame number, and (x,y) coordinates, which may or may not include the time information, the element is captured in the video using a predetermined selection size (203). In this example it might be a circle of 30 pixels diameter, the measurement may be also of a different measurement unit. However, it could also be a different area defined by a certain shape and size as mentioned earlier. This example in FIG. 23 assumes that a method is used that compares a screen selection of the video frame at the location that the user clicked on with the images of specific key frames.

When the selected area at the selected location has been captured in the video using the (x,y) coordinates, there is an optional step where a few values are set. The variables have no effect on the overall outcome. They are simply one of many methods for counting the times a set of instructions have been run and to determine which were the previous instruction set the software processed previously. In this example, the count value is set to 1. With this the number of attempts are counted that the software ran Method 1 and/or 2. For both methods there can also be separate counts. In addition, the Screen Value is set to zero at the start. This ensures that the last value of any prior calculation is not used for the current calculation. Hence that number is set to zero to ensure that the Screen selection size of Method 1 starts with the lowest, smallest predetermined selection area (204). In case the method is applied where the entire screen is analyzed the screen value may be omitted. In one embodiment, Method 1 (211) and Method 2 (230) can be substituted by any other method.

Next the pixel cluster tracking software is started for this analysis (205). The software analyzes the selected pixels captured from the video, in this case with radius 30 pixels, for example, and then determines whether it can or cannot detect the selected element. As mentioned earlier the software may do a first analysis (206) to determine which method to apply and to check if the object is element by using the first frame (206) and a second frame as preciously described. There might be, for example certain light conditions or other parts interfering with the element that needs to be detected making it impossible to positively identify the element, in which case the method needs to be adjusted or a different method needs to be applied. This first step analysis is not essential for the overall process or method. It is just one step in the process that helps to ensure that the pixel cluster tracking software can positively detect the element in the first frame.

If the element is not detectable in this first analysis (206), a variable, let's call it ‘a’, is set to the value ‘0’ (208). This is optional and not a requirement. The variable ‘a’, and it could be a different variable, only helps to identify where the workflow originated from. Depending on the programming language used this could be also achieved with different if/then/or else instructions or similar methods. In this case it was the first analysis, which had a negative outcome. Next the variable c is checked to see how many times the Method 1 was applied (209) so far. The variables can differ and are only an example. If the value c=CN, where CN is, for example, number ‘5’, it instructs the software basically not to further increase the screen selection size, and/ or conduct another image analysis using a different method and pick a larger predefined area. This might be, for example, because the element cannot be tracked due to different reasons, such as, interference or the element being obscured by other parts, bad light conditions, etc.

Or there might be a situation where the element suddenly disappears within the predetermined time frame. If the number of screen selection increased is below ‘5’ attempts for example, or a specific predetermined maximum selection size has been reached, the Method 1 (211) is applied and the selection size is increased by a specific size or increment each time. In this case the radius is increased from 30 to 60 pixels, for example. The Screen selection is again captured in the video frame (not shown in this flowchart) and the count is increased from 1 to 2 attempts (214). Because the value ‘a’ was set to 0 (209), the process flows via (216) back to (206) where the element tracking software again determines whether it can positively identify the required frames to make the element trackable for the predetermined time of, for example, four seconds.

As previously mentioned the system may pick any number of frames with different times apart to calculate whether or not it can positively track the element. In case the software cannot detect the element in at least one frame (206), the region tracking software would again apply the first method (211) until value c or a specific maximum limit for the screen selection size has been reached (210).

If the maximum attempts have been reached for the First Frame analysis (210)(213) then the software would display a message to the user that the software is unable to identify the element in the first frame (214). If the element is not trackable in the following frame calculation (208), then the element tracking software would attempt, after reaching the maximum allowable screen selection size or factor (210), to proceed via (212) to Method 2 (230). Method 2 (230) would be applied when Method 1 has failed to detect the element. It would, for example, also be possible that the element could have disappeared from screen, with the option of reappearing at a later stage. In another embodiment the element tracking software could suggest that it found the element at a later Frame n and it could in addition make this suggestion as this would then meet the 4 second object tracking requirement. In another embodiment, the screen selection size value after the calculations have been completed and the element is detectable (222) or not detectable (214) would be set to the zero value (not shown).

As described earlier, in Method 2 (231) the element tracking software determines at which frame number the element is not visible or trackable anymore. It would then determine whether the element might be trackable in the preceding frames, before the frame that the user clicked on the element. If, for example, after 3 seconds the element cannot be identified, the system would try to determine whether the missing 1 second can be taken from the preceding frames. In that case the Screen Tag would be placed 1 second earlier than the frame that the user actually clicked on to pick an element.

Alternatively, in another embodiment the system might check the following frames beyond the 4 second mark if it is unable to detect the element. This could be restricted to a certain time value, for example, 30 seconds in order to prevent the system from spending too much time detecting a four second interval closest to the location that the user clicked on. In addition, the further the location is away from the point that the user originally chose to be annotated the less likely that element might be an alternative because the scene is for example different.

The user may be prompted to agree if the system selects the earlier position in which case the video might be skipped to that position. If this method (230) is not successful and the element cannot be positively tracked (231) a message would appear stating that the element cannot be tracked (214). If the tracking software can positively detect the element (222), the element tracking is deactivated for this tracking calculation (239) and the system would render a Screen Tag at the selected position (240). In one embodiment a delete button might be placed so that a user can delete the Screen Tag, so that the Screen Tag can be deleted (241). This might be optional and or occur concurrently with step (240).

Once the Screen Tag (240) is placed the user can select to create or choose a title or icon for a Category Tag to define the category for the information what is being added to the Screen Tag (249). In one embodiment a separate Tag is created. This Descriptive Tag (249) contains all the information including the category, for which in another embodiment there might be a separate Tag, called Category Tag. The idea is that in one embodiment the Category Tag is visible on screen and that the descriptive information of the content is available when a user opens the Category Tag for example.

The user can, for example, enter a Title, a description or comment, message (244), a URL (245) or any other data, files, or information to either the Screen Tag, or the Descriptive Tag or Category Tag. In one embodiment, the system may use the Tags to place advertising. In yet another embodiment the Screen Tag or Descriptive Tag may contain a chat or messaging services that allows users to leave live comments. In this case users can chat using audio, text or video within the Tags at a specific location in a video. The system could track the chat interactions and display in which frame the collaborations are taking place. By using what is known as heat maps it will show other users where collaborations are or have been taking place in a movie.

In one embodiment Screen Tags, Descriptive, and Content Tags may be activated and visible for specific user groups. This helps in educational environments where the same video is being used for different classes for example. One class will receive one set of Content Tags while the other receives a different set of Content Tags. This might also be used where Tags are used to place advertising messages. In this case Tags open automatically, if the video has paused in the frame containing tags. A user can then close this Tag containing the ad first.

It is also possible to select and add a video (246) or another file. This video might be of any type or format and might be preconditioned or converted to meet a specific format for optimized streaming performance (247), the methods of which are commonly known today. The user can at any time close the Tag (248) or cancel (252) the entries, or delete the Tag (250), in which case the Screen Tag and or Tags are removed. The video that is uploaded may also contain Screen Tags or a user can add screen tags to this video following the same process as described in this invention. When the video or content has been uploaded to the server (247) and the Tag(s) have been minimized or closed (248) the video playback may resume (260) either manually or automatically from the frame position where the Screen Tag has been placed at.

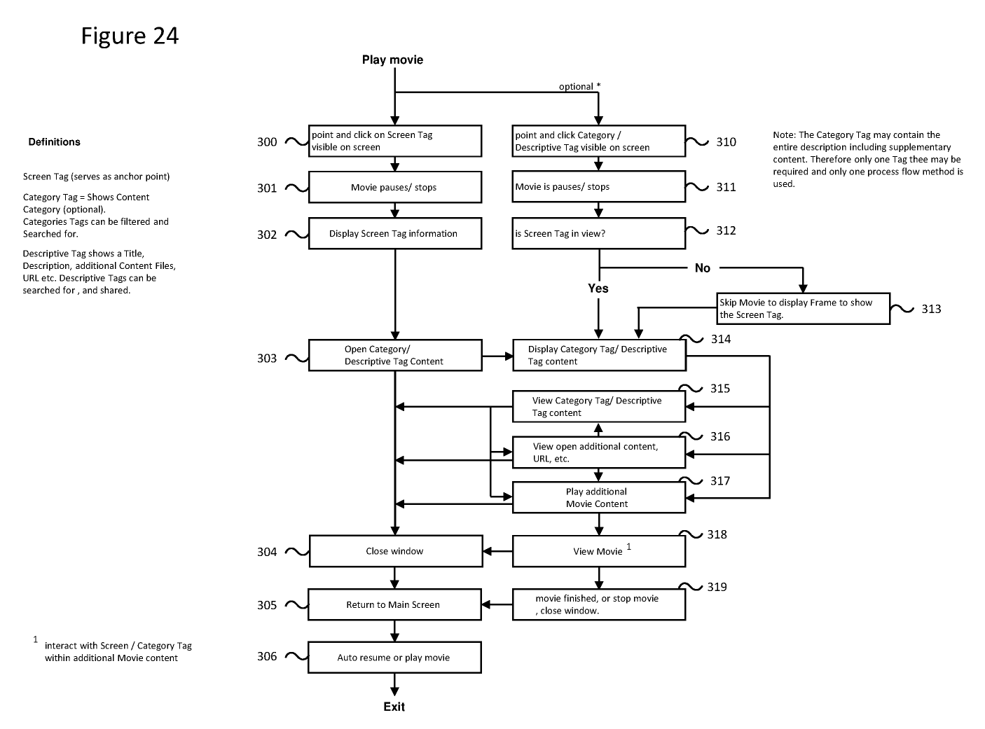

FIG. 24 describes the method by which a user would interact with a video containing Screen Tags. This process starts by playing a video that contains at least one Screen Tag that has been added as previously described in this invention. By clicking on a Screen Tag that appears during a video playback (300), the video would pause or stop playback (301). In another embodiment the movie may pause whenever a user hovers over a Screen Tag. In which case the Screen Tag could slightly enlarge showing the Screen Tag that the user hovered over. This would either show the relevant Screen Tag information immediately or in another embodiment require a second click, or with a delay, to show the Descriptive Tag ad or Category Tag (303). In one embodiment it would display and highlight, or with other visual cues, bring to the user's attention the Screen Tag of the Descriptive or Category Tags (303) that the user selected on screen. This would be the case when the Screen Tag and the Category Tags are separately displayed. When several Category Tags or Descriptive Tags are shown for example on the bottom of the screen the user may click on any of them, which will then highlight the corresponding Screen Tag.

When the user finishes examining the content he can close the Tag Window (304). A user may be automatically redirected to the Video or this can occur manually (305). Then the user can continue video playback by clicking on the video controls or this process could also start automatically (306).

In one embodiment, a user can also click on the Descriptive Tag or Category Tag that are visible on screen (310). These remain visible for a longer time than the Screen Tag as mentioned before. When a user clicks on a Category or Screen Tag the video is paused and if the Screen Tag is not in view (312) the video is skipped to the position where the Screen Tag is visible (313, 314).

The user can then interact with the Tags (314) and explore the information, content (315, 316) and play a video for example (317). A linked video will appear and may also contain Screen, Descriptive or Category Tags with the relevant annotations and content (318). Please note that in this invention any kind of content can be displayed in Tags. This may for example include also advertising, which might use a different method for interacting as described here. When closing the window or Tag (304) the system returns to the screen of the main video where the user clicked on the Category, Descriptive or Screen Tag (305). Then the user can continue video playback by clicking on the video controls or this process could also start automatically (306).

The use of Screen Tags and Category Tags offers an inherent advantage over existing annotations. Tags may contain supplementary information that is far more detailed that would normally not be shown in a traditional video. Moreover, all users can use Tags to annotate videos and they can be shared with other users. Because of this far more data can be collected because users interact now with the videos and the tags. All interactions, annotations, tags are stored and provide valuable information for the content publisher and author as well as advertisers. By analyzing the data using business intelligence it is possible to determine the level of interaction on a frame basis. This helps to distinguish the most valuable sequences in a video. Moreover, the value of a video can now be better compared to other videos because the level of user interactions and number of tags provide additional cues to whether or not to view a particular video. For advertisers this is helpful because ads can now be placed precisely at those locations where they are most relevant and where most interactions take place.

### Video Commenting and Messaging

As discussed above, in some embodiments the Screen Tag or Descriptive Tag may contain a chat or messaging services that allows users to leave live comments or message each other.

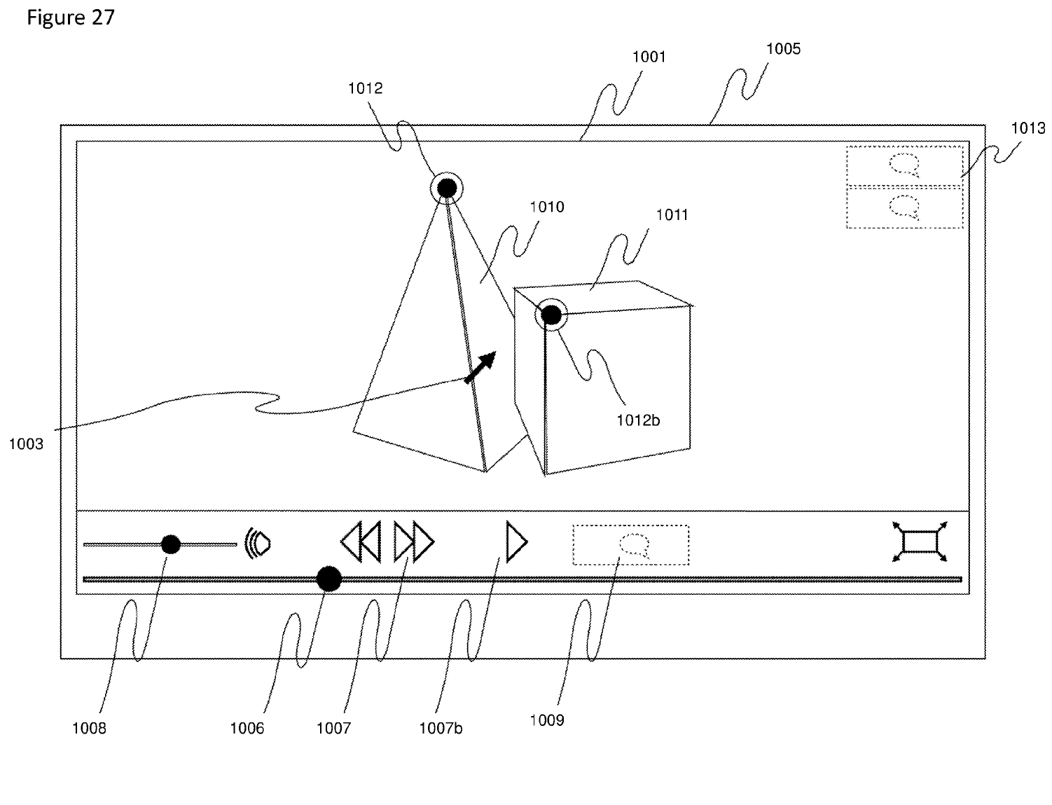

FIGS. 27 through 31 demonstrates how a user will view Message or Comment Tags in a video in the present invention. The examples shown in these figures refer to a video only. The same method would also work for an image but without a video player, and image detection is rather simple, because the identified object need not be tracked over several frames because we are dealing with a single image.

FIG. 27 shows a video player (1001), featuring standard movie playback controls and functions (1006), skip (1007), play (1007b), audio volume controls (1008), as they are commonly found on existing video players known today. These functions allow users to control the video playback and may include other features such as screen scaling, closed captioning, resolution settings and other functions, which are not relevant in this example. The video player controls are visible when a user clicks on the video of a website (1005), or initiates video playback similarly to how existing video players function.

In this example in FIG. 27, the video is paused at a specific point in time, showing a scene at a Frame F, with two objects, a pyramid (1010) and a cube (1011). A cursor (1003) is shown, but may not be a requirement depending on the type of computing device used. In this example, the cursor (1003) is shown for demonstrating the interactions.

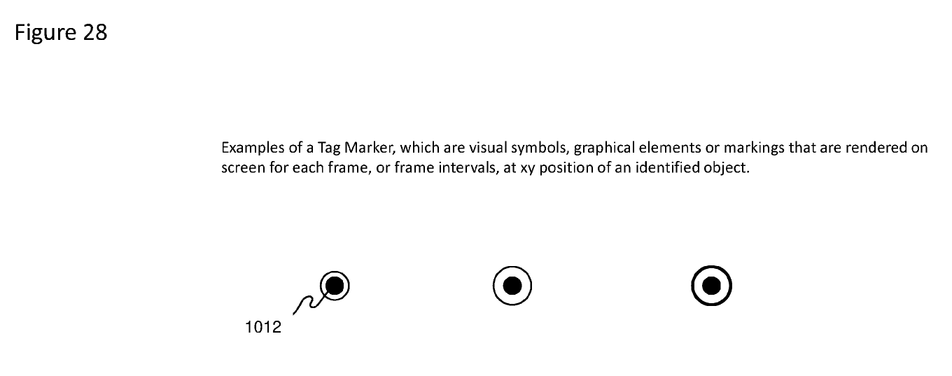

Both objects show a Tag Marker (1012)(1012b) superimposed on each object, each being interactive elements that can be clicked on, or upon mouse over are activated to reveal specific messages or comments that are placed in Message or Comment Tags. A Tag Marker (1012) features a visible symbol, or graphical element, or marker of a particular size, which may differ in shape, size and color depending on the type of content the Message or Comment Tag is associated with as shown in FIG. 28, whereby the linkage is not a physical connection but rather an association.

Whenever there is a Message or Comment in a Video, a Tag Marker (1012) appears at the object's location in a video. Both Tag Markers (1012) and Message and Comment Tags (1020) are layered information and are independent of the actual video or image. They are rendered by the system and displayed at the (x,y) coordinates of the identified objects for a specific predetermined duration of, for example, four seconds.

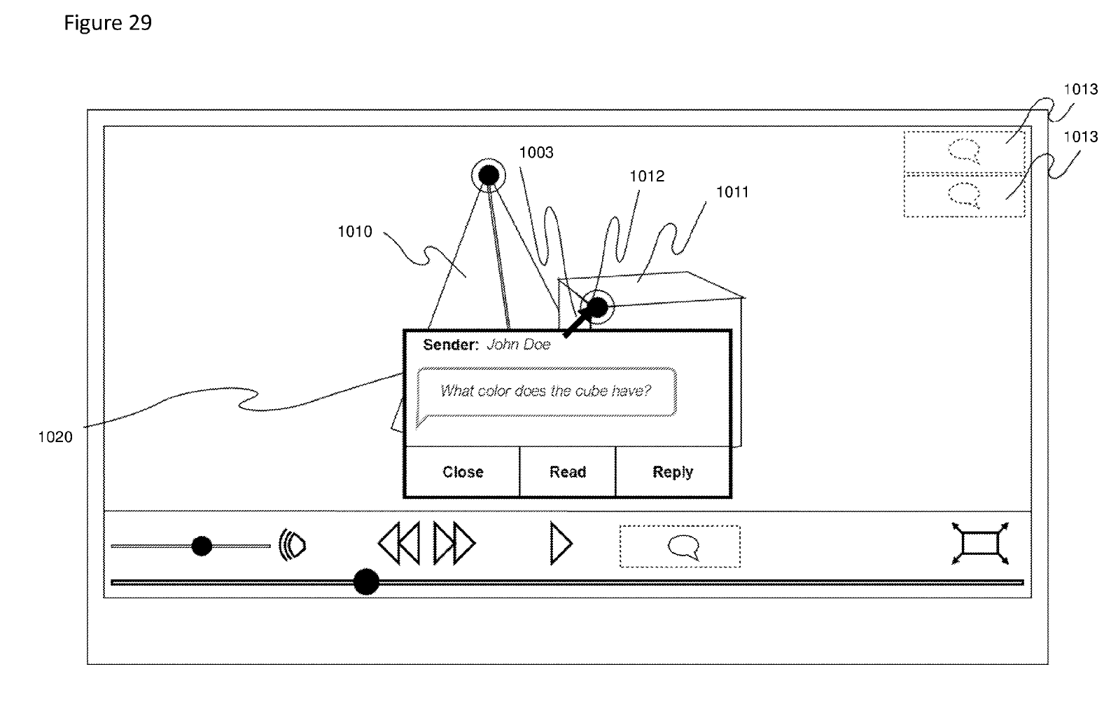

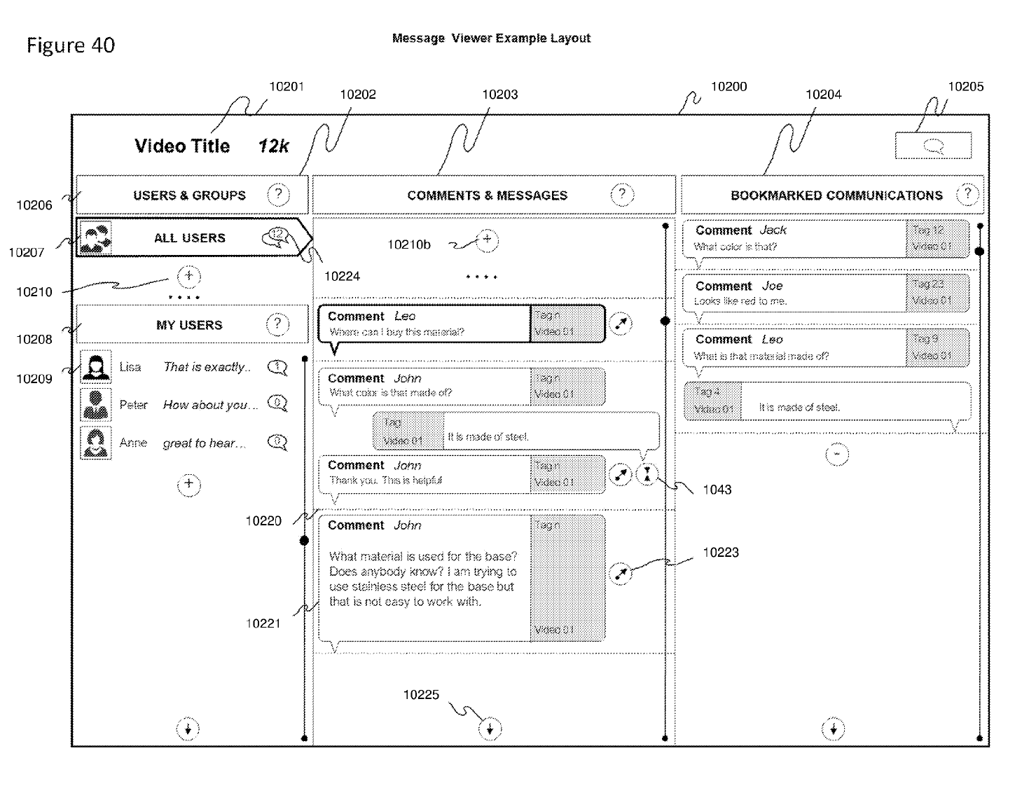

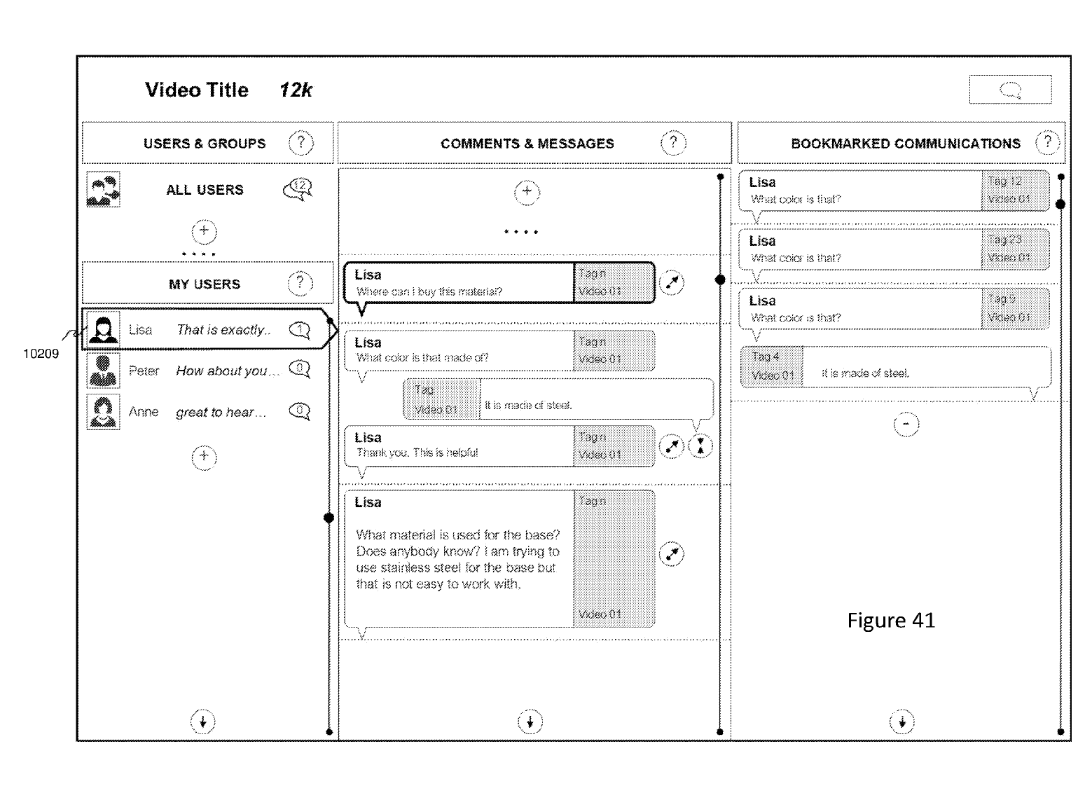

When clicked upon, the Tag Marker (1012) shows the Message or Comment Tags (1020) in their containers, which contain the actual messages, comments, recipients as shown in the example in FIG. 29. The Message or Comment Tag (1020) is associated with the Tag Marker (1012) and associated or linked to the cube (1011). The Message or Comment Tag container (1020) opens in a view on top of the video or in a designated message viewer, as shown in the example FIGS. 40 and 41, whereby the Tag Marker (1012) may be highlighted, or marked otherwise, to show the corresponding Message in the Message Viewer.

When a message or comment Tag is shared with other users, for example, the system will maintain the relation of the Tag Marker to that identified object in the video and accordingly open the video and show the frame and the object (1011) that the Message or Comment Tag (1020) is associated with.

In embodiments of the present invention, Tag Markers (1012) are used so that the actual Message or Comment Tags with the message containers do not obstruct the view of the actual video or image. In another embodiment the Tag Markers could contain the actual Message or Comment Tag so that they are one unit, associated with an identified object in a frame of a video or image.

The particular size and dimension, form and color of the graphical elements for the Tag Marker or the actual Message or Comment Tags may vary. A Tag Marker (1012) as shown in FIG. 28, is clickable or interactive and may have additional rings to increase contrast to increase noticeability in various light conditions in videos and images. A user may during playback, or when the movie is paused, click or mouse-over the Tag Marker (1012) with a pointer, his finger, or any other pointing device or method, to reveal the actual information of the actual Message or Comment Tag (1020) as shown in FIG. 29. The relevant information, such as the message or comment is then displayed on screen (1020). In this example a message from John Doe asking “What color does the cube have?” is displayed. A user can then read and reply to the message and close the message to proceed exploring other visible Tag Markers, or continue viewing the content.

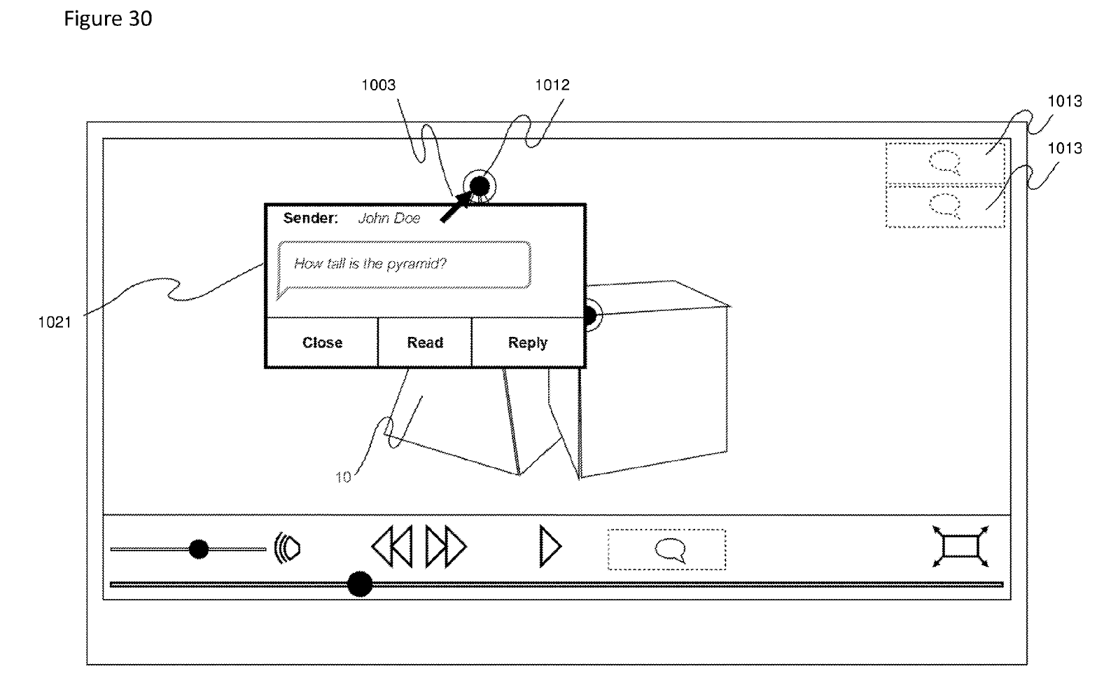

FIG. 30 shows another Tag Marker (1012) opening another Content or Message Tag (1021) related to the Pyramid (1010). In this example the Message or Content Tag (1021) contains a question “How tall is the pyramid?” and was sent by John Doe.

The illustrated embodiment uses two different types of Message and Comment Tags (1020). One is a General Tag (also referred to as a Topic Tag because it can be associated to topics which are not objects) and the other is an Object Tag. The former type of tag is associated with at least one frame of a video, while the latter type of tag is associated with an object, identified by a user in at least one video frame of a video, or an image.

A General Tag is associated with at least one video frame and not with an object appearing in a video. This type of Tag is shown at a specific time for a specific duration in a video. In news broadcasting, for example, messages are already used and displayed to viewers in particular scenes during specific events to highlight something important. However, in embodiments of the present invention, a Tag Marker that contains the actual message of a Message or Comment Tag are used, with the actual message displayed when it is being interacted with. The reason for using Tag Markers is that otherwise such Messages or Comments Tags with all their information would clutter the screen. In the illustrated embodiment these General Tags (1013) appear in a particular section of the video player, such as the top right corner, as shown in FIG. 27. Messages appear for a specific predetermined time and then disappear again from view. In case of multiple messages, the latest messages could appear on top and the older ones appear on the bottom. In the illustrated example there are two messages but there may be more.

A user can create Message or Comment Tags as a General Tag and the message is then associated with that frame, which is different from the way TV networks use messages which are triggered by the producer and displayed for a specific time. These messages in TV broadcasts do not permit other people to add and remove a message. In one embodiment the producer or content owner may authorize messages to be sent and/or comments to be posted.

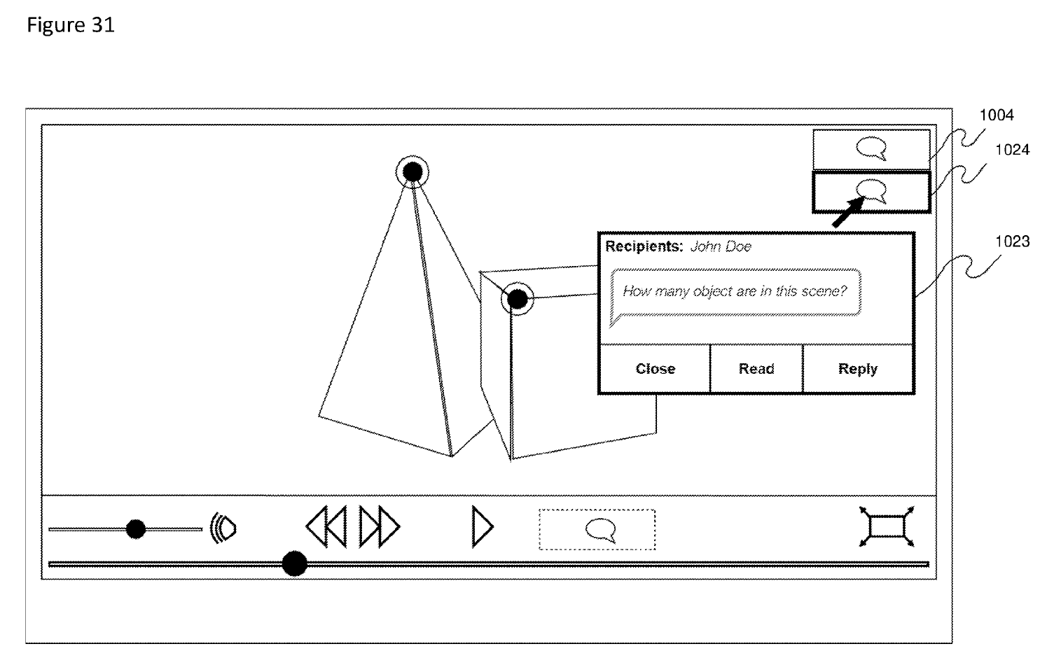

General Tags (1004, 1024) as shown in FIG. 31, are preferred over Object Tags in places where, for example, conversations take place. Because such conversations are not associated with a physical object in the video or image, a General Tag (1004, 1024) is therefore the preferred choice. A General Tag (1004, 1024) can be placed on screen at position (1013), shown in FIGS. 29 and 30 in a dashed area. The General Tag (1004, 1024) is then associated with that particular frame, for a specific time of, for example, four seconds. During playback these General Tags (1004, 1024) will appear on screen and might also appear longer in view. The General Tag may appear differently than the Object Tag, because the General Tag does not follow an object for a predetermined time and does not obstruct the view.

In embodiments of the present invention such General Tags (1004, 1024) are created for particular frames and may contain not only comments from the authors or publishers but also messages or comments posted by users. These messages and comments are then associated with the particular video frame or frame sequence of that video.

During playback these General Tags (1004, 1024) will then appear in the frame in the area (1013) as shown in FIG. 31 and FIG. 29, and depending on whether they are Comments or Messages the shape and color of the Icon or graphical element may differ so that users understand whether it is a comment or a message (1024) as shown in FIG. 31. The General Tags (1004, 1024) disappear again after a predetermined time, which may be for example four seconds, which is sufficient for a user to notice a Tag and to interact with it. Users are able to access these General Tags (1004, 1024) in order to view comments, messages or other forms of communications that are posted at a particular frame in a video or image. As a result, messages and comments appear to viewers in the frame where they are relevant.

The other type of Tags is Object Tags, which can also contain messages and comments but, unlike General Tags, they are associated with an object identified in a video or an image. Embodiments of the present invention enable comments or messages and other forms of communications to be associated or linked with an object appearing in frame of a video or an image using Object Tags.

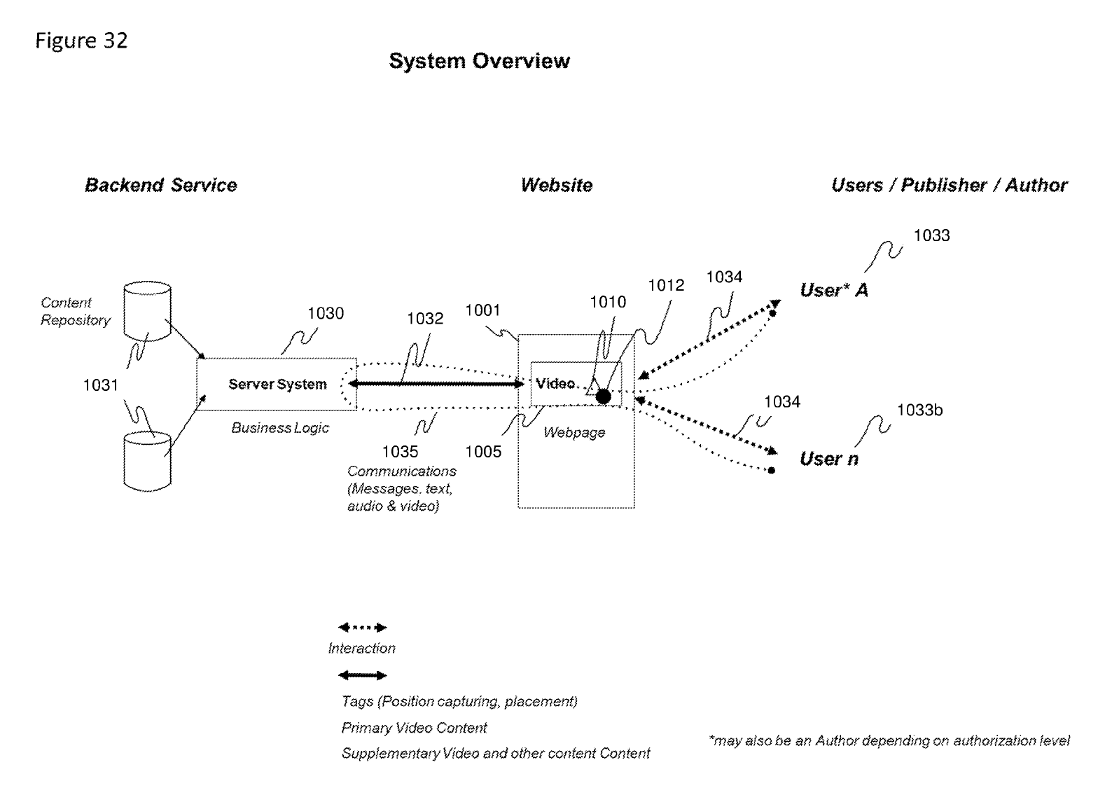

FIG. 32 shows an overview of one embodiment of a System for hosting embodiments of the present invention. The System consists of a Backend Service (1030), which is running the business logic, with at least one Content Repository (1031) for messages and content, and a Website (1001) providing content to the service through the internet. In another embodiment different video services stream content to the website (1001), and the business logic (1030) handles the tags and communications (1005). In yet another embodiment, the communications (1005) may be separate from the business logic. In another embodiment the video player (1005) is part of an iframe or similar framework, and associated communication traffic (1035) and tag related information is routed to the server (1030), whereas all other content such as the website (1001) and other content including advertising for example, is residing on a different server or servers, which are not shown.

Users (1033a, 1033b) are viewers, authors or publishers, who access (1034) a website (1001) that shows at least one video (1005), or image. The Website (1001) may be a video hosting site for example, showing multiple videos on a website or multiple images or a combination of both, whereby each video using the present invention is connected (1032) with the Server System (1030). In this scenario, the primary content or video content is residing on in a repository on the Server System (1030) however there may also be instances where that content is residing on a separate server or repository, which might be a third party.

In this example, a video (1005) is played with a video player that controls the video playback, as shown for example in FIG. 27. FIG. 27 shows an example of a video player, which has standard known movie controls (1007, 1007b) and Messaging or Chat (1009) functionality, or similar functionality, for establishing different types of communications such as sending messages or comments. In another embodiment the Chat or Messaging Function (1009) may be placed elsewhere in the interface.

An authorized user (1033) can create a Message or Comment Tag by creating a Tag Marker (1012) in a video (1005). In case a user is viewing a video (1005) on a website (1001), he would pause the movie by clicking the pause button or stop button of the video player or by clicking a key, such as the spacebar, which then stops or pauses the video. If the user wants to create a Message or Comment Tag on an identified object (1010), the user would click on the object (1010) he wants to comment on and place a tag at that objects location (1012) in the video (1005).

The system will then check the frame number, and or time stamp of that videos frame, and determine the (x,y) coordinates for the position and location of the identified selected spot of the objects in order to place a Tag at that location. Before the system (1001) can create the Tag Marker (1012) and the Message or Comment Tag at that location, the object tracking engine on the server (1001), or in another embodiment an application running on a computing device, would determine whether the object (1010) or pixel region of that object is trackable and visible for a predetermined time of, for example, four seconds as discussed in greater detail above.

If the object is visible and the pixel region is trackable throughout a predetermined time of, for example, four seconds, of a video a Tag Marker is placed at the location of the object and the system will then render for the predetermined time of, for example, four seconds a graphical symbol or Tag Marker (1012), as shown in FIG. 32, at the calculated position (1012) that is superimposed on top of the object at the selected location in the video. Then a Comment or Message Tag is created and associated with that Tag Marker (1012) at that location and the message or comment is sent (1035) for subsequent sharing with other users. Both messages and comments are associated with that location for all viewers to see during playback in the video frames. If users are communicating or chatting with each other the associated traffic (1035) is routed through a message service residing on the system server (1030) or in another embodiment a different external service.

During playback the Message or Comment Tag would appear at that location of the Tag Marker (1012), which can then be interacted with during playback or when paused. In another embodiment messages that are intended for specific users will only appear for those users who they are intended for at the objects' identified locations.

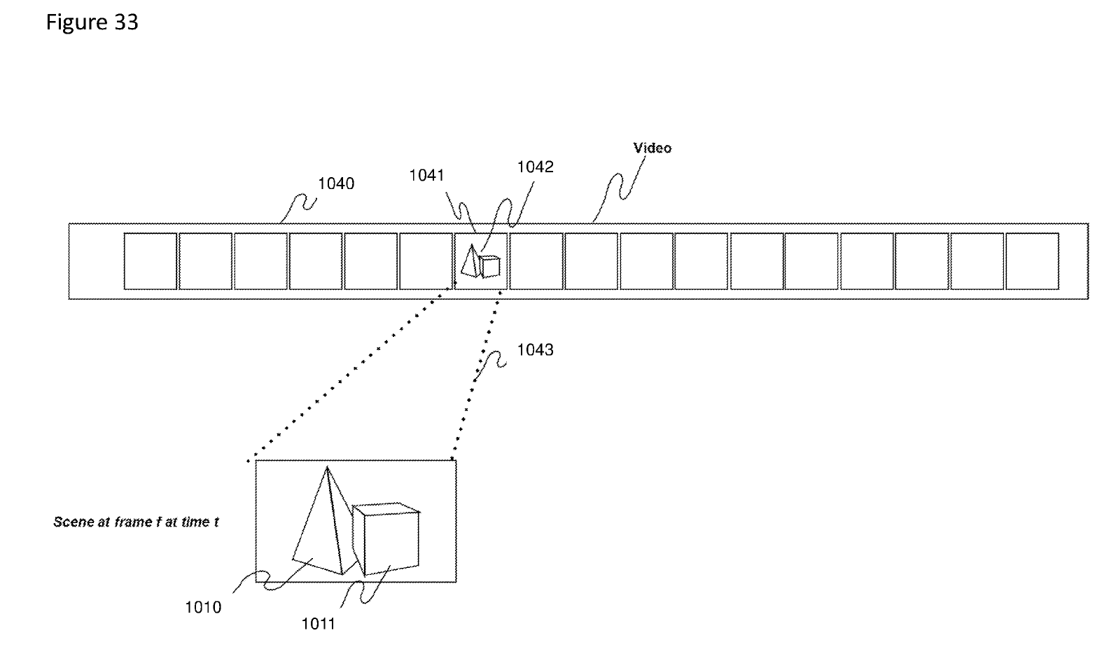

To explain this in more detail, FIG. 33 shows a video (1040) with a series of frames. One frame (1041) shows two objects (1042) in a single frame at frame f, and or at time t. In this example there are a cube (1011) and a pyramid (1010) in this frame (1041), which are enlarged (1043) in order to explain the tracking and placement of Message and Comment tags on objects.

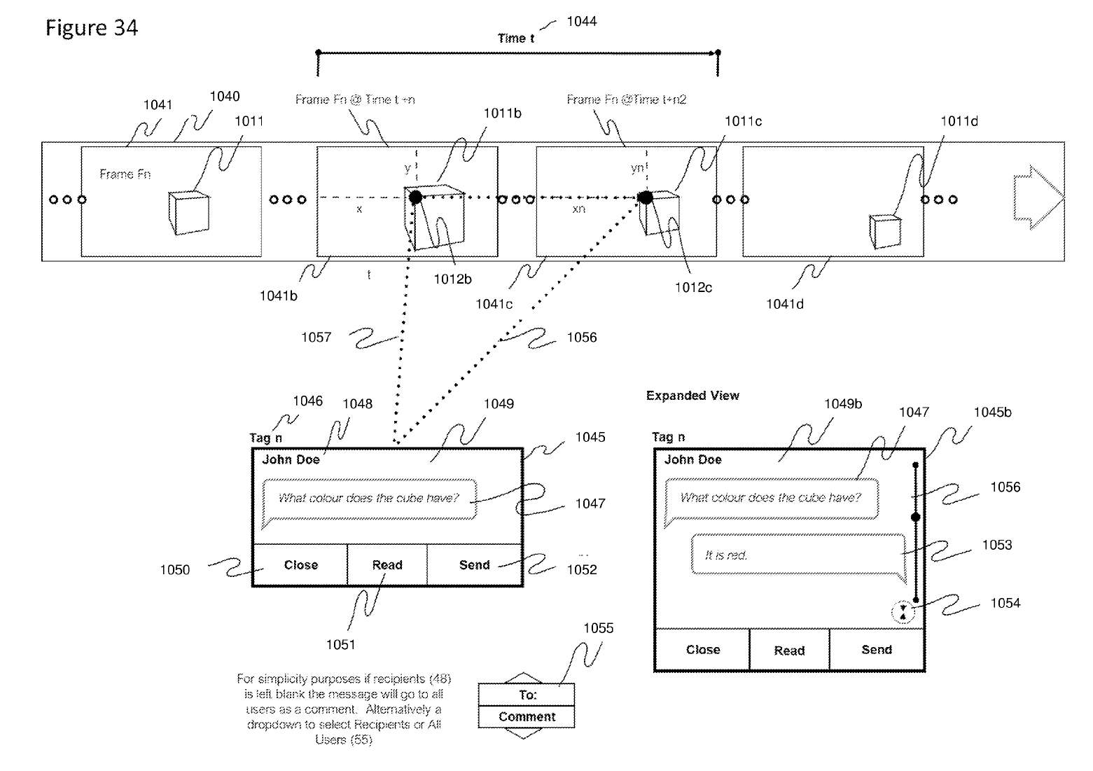

FIG. 34 shows that same video (1040) but showing several key frames (1041, 1041b, 1041c and 1041d) spaced at different time t intervals t, t+n, etc. Frame Fn (1041) shows a cube (1011) in perspective as an example. As the video plays the position and view of the cube (1011) changes over time as shown in the other frames (1041b, 1041c, 1041d) at positions (1011b and 1011c). A user clicks in the video, or pauses the video, at frame position (1041b), which shows the cube at time 0. The user then clicks, for example, on the left top corner (1012b) of the cube (1011b), where he intends to post a Message or Comment Tag, which will then be associated with the actual location of the top left corner of the cube (1011b) and (1011c) for the duration of, for example, four seconds.

The system will then analyze the image by means of object tracking. Instead of processing the entire image, in one embodiment, the system would capture and analyze a predefined area around the clicked location (1012b) of the image in order to save processing resources as discussed above.

The analysis determines whether the object will still be visible for a predetermined time of, for example, four seconds, so that a Tag Marker (1012b), to which the actual Message or Comment Tag is associated, can be placed at the desired location. The system will analyze each of the frames (1041b) through (1041c), which may be (at 25 frames per second) 100 individual frames, for the required predetermined time of, for example four seconds. This can be done in different methods as described earlier. For example, in sequence or randomly or following a specific pattern or algorithm, and determine if the tracking of the object is possible for this predetermined time of, for example, four seconds. If the tracking can be performed, the system will then create a Tag Marker (1012b), which is then rendered for each of the frames at the chosen locations of the object (1012b, c) for the four second interval and superimposed on the video frame (1041b) and subsequent frames of a video (1040) during playback.

Then the system will then create a Message or Comment Tag (1049), in this case Tag n (1046) as shown in FIG. 34. The Message or Comment Tag (1049) is basically a container (1045) that allows a user to add one or several recipients (1048) by selecting or typing their names, or in another embodiment, by selecting from a dropdown (1055) or similar command, to address a comment to all users viewing the video. In addition, the user can add a text in a text field (1047). A post or send button (1052, 1052b) allows the user to post or send the message. Depending on whether this is a Message Tag, sent to specific users or groups or a Comment Tag, which is intended for all users, the naming of the labels may vary accordingly. A close button (1050) allows the user to close the Message or Comment Tag (1049). In another embodiment there may be other buttons, such as, delete, forwarding or bookmarking and read/and unread (1051). Message or Comment Tags (1049) can be opened and expanded to reveal the entire conversation as shown in (1049b). An expand-view button (1054), or similar function, allows a user to expand or collapse the Message or Comment Tag (1049b) and a scrollbar (1056) helps to find Chat messages.

Each Message or Comment Tag (1049) has a unique identifier and is linked to or associated with the place where the Tag Marker (1012b, 12c) has been placed on the (x,y) position of object in each frame. Note that naming of Tag n (1046) is not physically required. It may be a unique identifier or title associated with the message or comment Tag (1049) and be either visible or invisible.

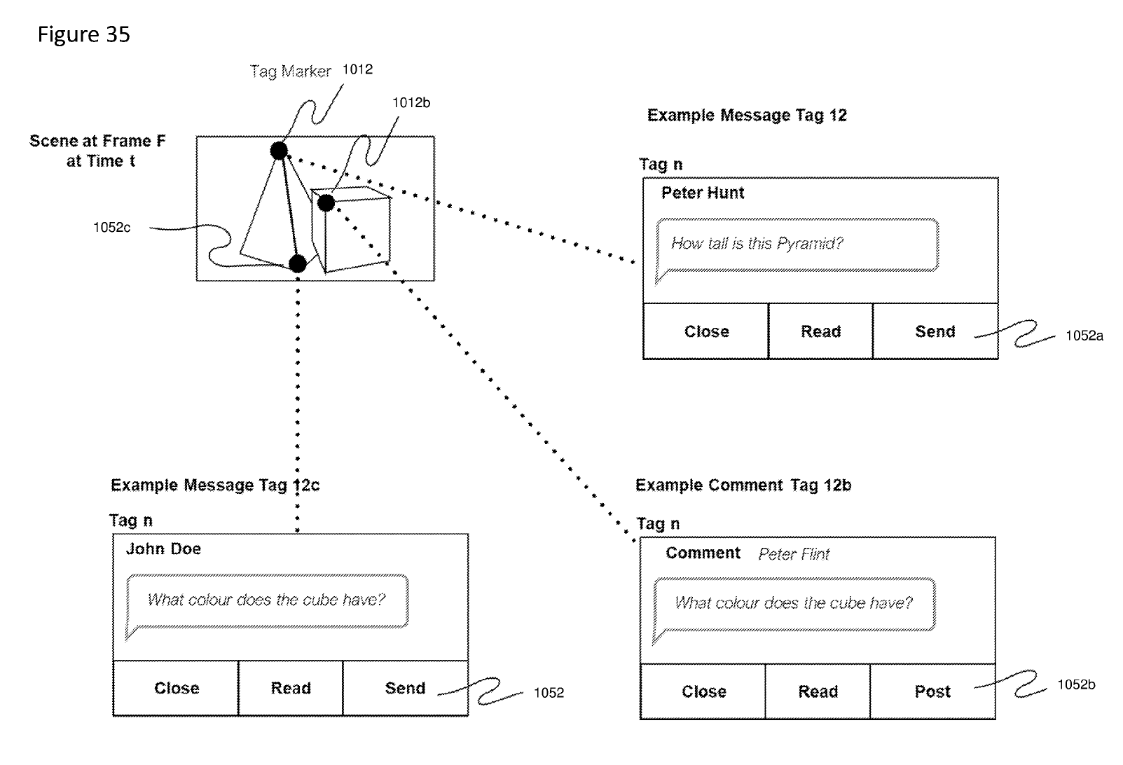

FIG. 35 shows in another example how several Tag Markers (1012,1012b,1012c) placed on two different objects in a video frame are associated with several Message and Comment Tags.

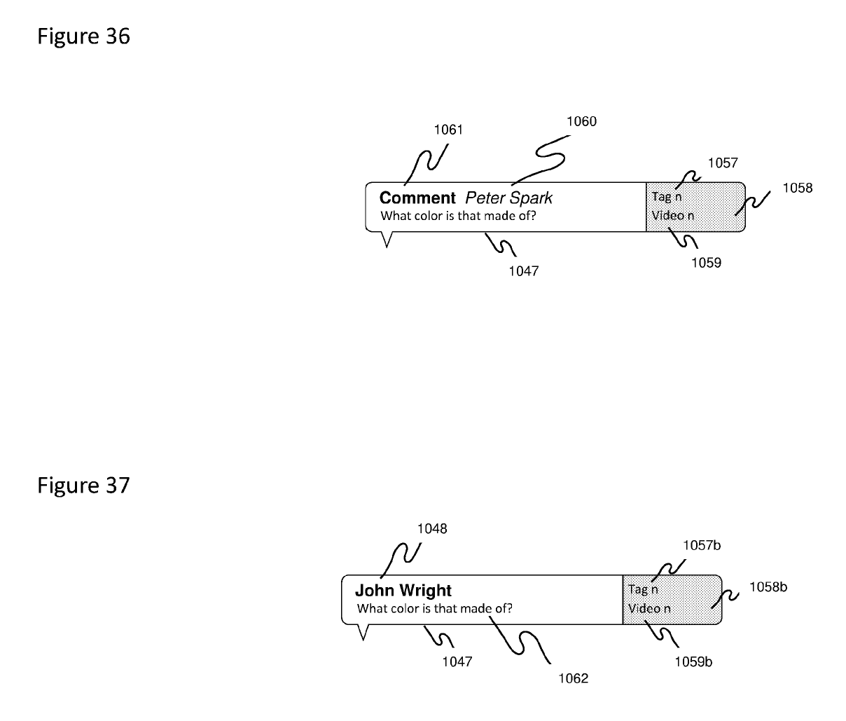

FIGS. 36 and 37, show example layouts of the Message or Comment Tag container (1047) here in the shape of a speech bubble. However, the design of the message tags can be of any shape or size. Messages can be sent as comments (1061) to all users viewing the video or image, or to at least one specific user (1048).

The message container (1047) shows in another embodiment a reference area (1058), which is a section or part of the message Tag, which can be either visible or be displayed on demand It shows relevant information concerning the linked or associated video. The information that is displayed can be the video title (1059) that the Tag is linked to and in another embodiment also the Tag Type, which can be shown also as an icon (not shown), or Number or ID of the Tag (1057), or a Title of the Tag. In this example, the information is “Tag n” (1057, 1057b).

In another embodiment the reference area (1058) can be associated with the entire chat message conversation and not with each single message (1047).

Message or Comment Tags can be viewed both in a video, or in a dedicated message area, which can be made visible on request or it may be visible below the video player. An example of such a Message Area (10200) is shown in FIGS. 40 and 41, where all incoming and outgoing messages can be viewed. Each of the messages is linked to a specific Tag Marker in a video.

In this example, the message viewer (10200) is split into 3 sections (10202)(10203) and (10204) and uses text messaging. Video and audio communications facility is not shown but they operate similarly. One section (10202) lists the users and is split into my users and all users, which is intended for sending and receiving comments which can be viewed by all users viewing a video. Additional groups and users can be created and added by clicking the ‘+’ symbols. In another embodiment the chat and message section may be separate from the comment section.

The comment and message section (10203) lists messages as they come in. By clicking on All Users (10207), the corresponding comments of all users are displayed in the comment and Messages area (10203). Unread messages are highlighted or otherwise visually marked as unread. Users can reply to a message or bookmark a message by clicking on the corresponding symbol (10223). Messages can be expanded or collapsed by clicking the collapse and expand symbol (1043). Specific messages that are bookmarked are shown in the bookmarked and communications section (10204), which is an optional area. This area is intended to follow up on specific messages and collect messages that are of importance.

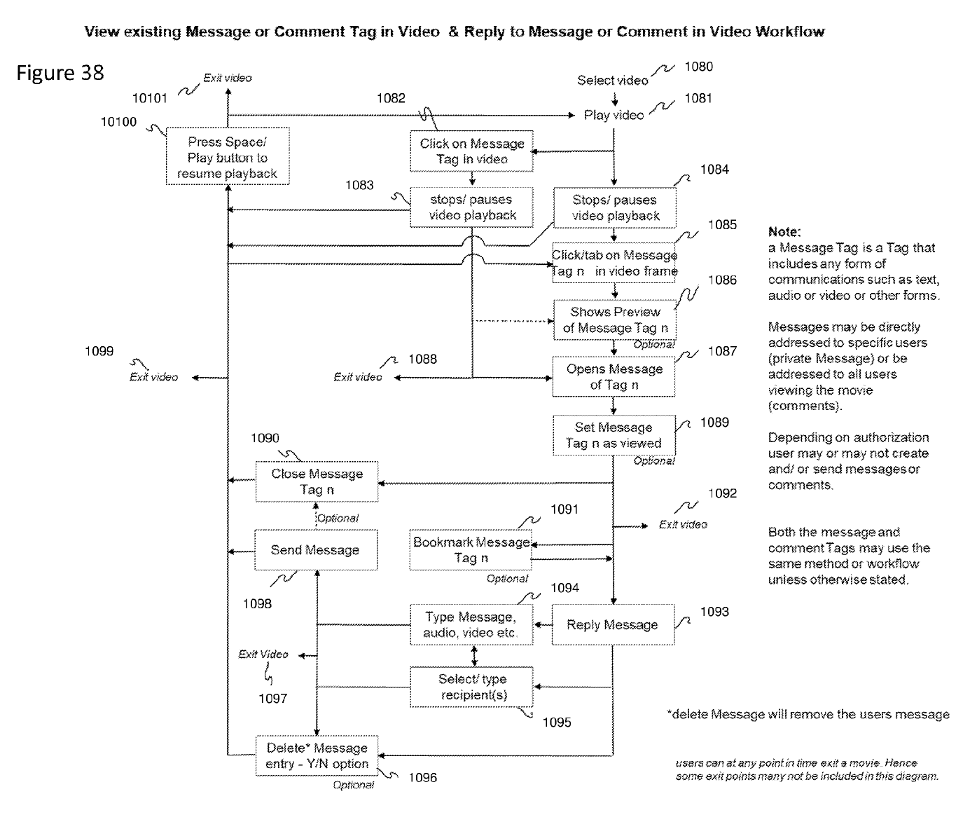

The Process Flow in FIG. 38 explains how a user views a Message or Comment Tag (1049), either in a video that he is viewing, or how he can reply to a message or comment tag in a video. A user starts video playback (1081) of a video by selecting and clicking a video (1080) in a website that is receiving data from the backend services (1030).

If the user detects during playback a Tag Marker (1012) he has two options. He can either click on the Message Tag (1082) or Tag Marker (1012) in the video, which then stops or pauses video playback (1083). On mouseover or when clicking the Tag Marker (1087) the Message Tag Container opens and shows the message along with the relevant information. Or the user stops or pauses video playback (1084) by either pressing a button, such as the spacebar, or the pause button, or by clicking anywhere in the video. The user can at any point in time resume playback (10100).

When the message has been opened (1087) the system may, in another embodiment, set the Message or Comment Tag (1049) as viewed (1089). This can be accomplished in different ways such as by highlighting or removing a highlight, or adding a visual marker next to the message indicating that the message has been viewed. The user has the option to close the Message Tag (1090). He can also exit the video at any time (1099) (1092), resume playback of the video (10100), or if available select another Message Tag visible in the video (1085).

A user can also have several options, such as, book-marking (91) the message, which will store the message or comment in a separate area for further review, or replying to the message by selecting ‘Reply’ (93). The user can then either start adding the recipients or by typing a message or comment as mentioned earlier. At any time the user can still delete the message or comment (96) or exit the video (97). To send the message or comment the user selects ‘Send Message’ (1098), which then sends the message to the recipients, who will receive a notification. In another embodiment, once the message or comment has been sent or been posted, the Message or Comment Tag (1049) may also close (1090). For sending Comment Tags, which is to all users, this command may be called for example ‘Post’ instead of send. When a user opens a Message or Comment Tag (1049) in the Message Area (10200) it will open on request or automatically, the corresponding frame of the video where it has been linked or associated to.

Users can also create Messages or Comment Tags (1049) in videos or in the message or comment area (10203) as shown for example in FIG. 42. Creating Message Tags may also be restricted depending on the usage scenario and the author or publisher would be able to restrict others from creating messages and other communication methods for specific users and/or groups.

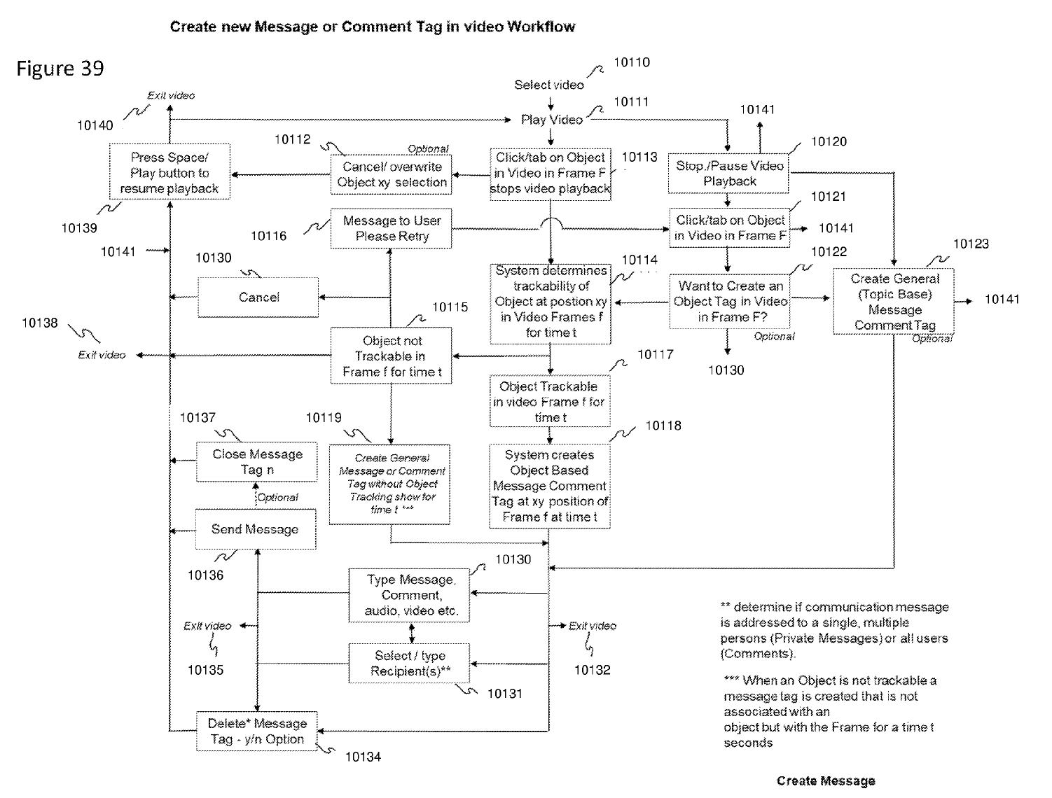

FIG. 39 explains in detail how a user would create a message or comment Tag in a video. In case of a still image the process will slightly differ and is not explained in this workflow. A user would select a video (10110) and play the video (10111). The user can at any time stop the movie (10120) and click on an object he identified (10121) which then creates an Object Tag (10122), associated with an object. Or he can create a General or Topic Tag (10123) associated with the Frame.

In the event that a user identifies an object he wants to comment on or create a message for, he could also click during movie playback on the location of the object (10113), or in another embodiment make a selection around the object, or select the object. In another embodiment the user could select an area, or position of a predefined object, such as a cube or square, which may be transparent or outlined, on the desired object where the Message or Comment Tag (1049) should be associated to. The idea is that the user decides the location or selection so that the System can use it to associate it with the Message or Comment Tag (1049). In yet another embodiment, the user has the option to reposition the selection in case the system is unable to track the object, or because the user is not happy with the selected object. In such case he would move the selection area, or the Tag Marker (1012), to a different location. This action would also immediately stop or pause the video playback. The user can also press the spacebar to continue playback (10139), which will then cancel the Object Tag creation and cancel and overwrite the (X,Y) position for a tag in the database (10112). In another embodiment, this step (10112) will not make a cancelation or deletion but instead not store the (x,y) coordinates values into the database, and leave the values in memory until a different object tag is created which then overwrites the values.

If required the user can manually skip forward or backward to find the most suitable location for the Message or Comment Tag to be placed. To make this procedure easier, there could be in one embodiment, at least one button that has a skip-forward by one second interval and skip-backward by one-second interval functionality. In another embodiment the value of time increments could be preset and the button function would be updated accordingly. This skip functionality would make it easier for a user to jump forward or backward in predetermined increments and to visually inspect whether the object is visible for a predetermined time of, for example, four seconds, so that the system can actually track that object for this amount of time (10114).

In another embodiment this could also be completely automated, whereby the system would calculate the time that the object is visible. Should the object be not detectible after a specific time, the system would check if the missing time could be used in the earlier frames. For this the system would go backward in the video in order to determine whether or not the object appeared earlier than the frame in which the user clicked on the object. If the object could be detected in earlier frames and then be visible for the duration of, for example, four seconds, the system would suggest to the user to retry placing the comment or message tag at the earlier frame where the Tag will then be placed on the object if authorized by the user.

If a user wants to create a Message or Comment Tag for a particular Frame, not associated with an object in the video frame or image, the system would, in another embodiment, first ask the user if he intends to create a General Tag or Topic Tag (10122) (which is NOT associated with an Object), or if he wants to create a Message or Comment Tag associated with this object that he selected or clicked on in the video or image. The system would ask this at this stage (before step 10114) because the General Tag Placement would then not require the system to perform object tracking calculations for all frames to determine whether or not the clicked-on object is trackable for a predetermined time of, for example, four seconds. In this case the captured (x,y) coordinates are not being used and the user proceeds with creating a General Tag or Topic Tag (10123). Then the General Message or Comment Tag will be associated with the Frame at time t and be displayed for a predetermined time of, for example, four seconds, and will not be associated with an object in the video frame.

In case of an object trackable tag, in another embodiment, the System could display this clicked or tabbed location by placing the Tag Marker (1012) temporarily at the position of the object where the user clicked or display any another graphical symbol, element or marker instead. The system could then, for example, prompt the user to confirm whether this clicked or tabbed location is the right position for the Message or Comment Tag. The user could then either confirm his action or input, try another location or cancel.

Once the user confirms the clicked location, the system would then determine whether or not the object the user clicked at, or selected, is in fact trackable for a predetermined time of, for example, four seconds (10117). For this there are several methods that the System would use to make this analysis, which are discussed above. If the Object is not trackable (10115) for the required predetermined duration of, for example, four seconds, the system would then inform the user that the object is not trackable and provide reasons in a pop-up message, for example (10116). The system could state, for example, that the selected object is not visible after x seconds, which is less than the required time of, for example, four seconds for a Tag to be recognizable for a user. Or the system could state that the object is not trackable due to interference or bad light conditions or give any other reason. The system would inform the user, so that he is aware that the tracking was not successful and special instructions shown to him may help and instruct the users to continue accordingly. The user then has the option to either try a different location, to retry the same location (10116), to create a General Message or Comment Tag instead (10119), which is associated with the frame only, or to cancel the Tag creation or placement altogether (10130), exit the video (10138), or resume playback of the video by pressing the play button, or in another embodiment, by pressing the space or another button (10139).

When the system determines that the Message Tag can be created (10118) for the predetermined time of, for example, four seconds, the system will store the (x,y) coordinates of the object's clicked position for each Frame f in the database. During playback the system would retrieve the position of the object for each frame f or at each time t, for the duration of, for example four seconds, in the data base and then render in real time the Tag Marker (1012) superimposed on the video frame at the required position of the object for a total duration of, for example, four seconds, after which the tag marker will not be visible, regardless of whether the object is still visible.

At any time during playback the clickable graphical element or tag marker (1012) can be interacted with, such as, by clicking it or by mouse-over or other methods, to reveal the Message or Comment Tag along with the information. In another embodiment the message will then also show up in the Message Area (10200) as shown in FIG. 41.

Once the Message Tag has been created (10118) for the frame at the (x,y) position, the user can then type his message in the message area (10130) and enter the recipient or recipients (10131) as shown in FIG. 40. In another embodiment, while the system is performing the object tracking calculations the user may already enter the information for the message such as the sender and the title (10130,10131). This will then reduce the waiting time for the user while the system is performing the object tracking calculations (10114).

At any time the user can delete the message (10134) and proceed with video playback (10139) or exit the video (10138). By clicking the send, return or similar button the message is sent to the recipients (10136). In case of a comment Tag the send button may be called for example ‘Post message’ or ‘Post’. The user can then proceed to playback (10139) or exit the movie (10138). User can at various points in the workflow exit the movie or cancel entries.

A user can subscribe to specific videos to receive notifications when new messages or comments appear. In another embodiment, a user could specify the frame or time range for which newly arrived messages or comments should be announced. This would allow users to be notified, for example, when a specific scene or object in a frame is unclear and additional information would help better understand the scene or topic.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method to facilitate communications, the method comprising:
receiving a selection of a location in a starting video frame from a user;
identifying a first group of pixels in proximity to the selected location;
determining whether the first group of pixels can be tracked through subsequent video frames for a predetermined period of time;
permitting the user to attach a tag to the selected location if the first group of pixels can be tracked for the predetermined period of time; and
enabling the user to associate a message with the tag.

2. The method of claim 1 further comprising playing the video while displaying the tag attached to the first group of pixels beginning at the starting video frame and finishing after the predetermined period of time.

3. The method of claim 2 wherein the tag is displayed to a first user and is not displayed to a second user.

4. The method of claim 1 wherein the predetermined period of time is approximately four seconds.

5. The method of claim 2 further enabling a second user to associate a second message with the message already associated with the tag.

6. The method of claim 2 further comprising displaying the associated message upon interaction with the displayed tag.

7. The method of claim 2 further comprising disabling the display of the tag during subsequent plays of the video.

8. The method of claim 1 wherein the attached tag is stored in a transparent overlay separate from the video.

9. The method of claim 1 wherein information concerning the attached tag is stored in a database.

10. The method of claim 1 further comprising selecting a second, larger, group of pixels in proximity to the selected location when the first group of pixels cannot be tracked for the predetermined period of time.

11. The method of claim 10 further comprising determining whether the second group of pixels can be tracked through subsequent video frames for a predetermined period of time.

12. The method of claim 11 wherein the predetermined period of time is four seconds.

13. A system to facilitate communications, the system comprising:
a source of video content;
a database of tags, each tag being associated with an element in a video content for a predetermined period of time;
a database of messages, each message being associated with a tag.

14. The system of claim 13 further comprising a player to display video content from the source of video content and at least one tag from the database of tags in proximity to the element in the video with which it is associated.

15. The system of claim 14 wherein the player displays the at least one tag in a transparent layer overlaid on the displayed video content.

16. The system of claim 13 further comprising an editor to receive a selection of a location in a video content from a user.

17. The system of claim 16 further comprising a pixel tracker to track a collection of pixels near the selected location through subsequent frames of the video content.

18. The system of claim 17 wherein the pixel tracker checks the presence of the pixel collection in a plurality of keyframes.

19. The system of claim 16 further comprising an object tracker to track an object near the selected location through subsequent frames of the video content.

20. The system of claim 19 wherein the object tracker tracks the object through the next four seconds of video content.
